(19) United States
(12) Patent Application Publication
(10) Pub. No.: US 2025/0365692 A1
(43) Pub. Date: Nov. 27, 2025

(54) CONTROL APPARATUS, COMMUNICATION DEVICE, CONTROL METHOD, COMMUNICATION METHOD, AND COMMUNICATION SYSTEM

(71) Applicant: Sony Group Corporation, Tokyo (JP)

(72) Inventors: Kazuyuki SHIMEZAWA, Tokyo (JP); Tomoaki MATSUMURA, Tokyo (JP)

(73) Assignee: Sony Group Corporation, Tokyo (JP)

(21) Appl. No.: 18/689,084

(22) PCT Filed: Mar. 9, 2022
(86) PCT No.: PCT/JP2022/010307

§ 371 Date: Jan. 22, 2025

(30) Foreign Application Priority Data
Sep. 15, 2021 (JP) 2021-150608

(51) Int. Cl. H04W 64/00; H04W 16/14; H04W 24/10; H04W 72/20

(52) U.S. Cl. CPC H04W 64/00; H04W 16/14; H04W 24/10; H04W 72/20

(57) ABSTRACT

A control unit (130) of a control apparatus (10) acquires a position of a first communication device (40A) and first quality information about a plurality of links. The first communication device (40A) is positioned in a first site in which a first base station (20A₁) for a first private network is arranged, and is connectable to the plurality of links including the first private network. The control unit (130) acquires a position of a second communication device (40B) and second quality information about the plurality of links. The second communication device (40B) is positioned in a second site in which a second base station (20B₁) for a second private network is arranged, and is connectable to the plurality of links including the second private network. The control unit (130) acquires first and second communication information about the first and second communication devices (40A and 40B). The control unit (130) uses the first and second communication information and first and second quality information to determine a communication route satisfying a desired quality between the first and second communication devices (40A and 40B), and gives notice of route information.

### FIELD

The present disclosure relates to a control apparatus, a communication device, a control method, a communication method, and a communication system.

### BACKGROUND

For example, conventional art is known to hold an optimal end-to-end (E2E) communication state in communication between terminal devices positioned at different points and connected to different base stations, according to wireless communication quality of the other side.

In this technology, on the basis of information indicating communication quality in wireless communication between a first base station and a first terminal device, a second base station limits transmission to a second terminal device.

### CITATION LIST

### Patent Literature

Patent Literature 1: JP 2007-202006 A

### SUMMARY

### Technical Problem

In recent years, a private network using local long term evolution (LTE) or local 5G has been tested or practically used. This private network can be established in a predetermined site (area) such as a factory, a business place, or a building.

Here, in the site, a wireless local area network (LAN) is installed, in addition to the private network, in some cases. Furthermore, the site is positioned within a coverage area of public LTE/New Radio (NR) operated by a network operator, in some cases. In this way, the terminal device positioned in the site is connectable to a plurality of wireless communication systems. In addition, a plurality of such sites can be provided.

In this configuration, it is assumed that communication (hereinafter, also referred to as P2P connection) using a peer to peer (P2P) technology is performed between the terminal devices positioned in the plurality of sites.

As described above, when the terminal device is connectable to the plurality of wireless communication systems, communication quality may change depending on which wireless communication system the terminal device is connected to. In this way, in a case where a plurality of communication routes can be selected for P2P connection, it is important to select a more appropriate communication route in order to further improve the communication quality of the terminal device.

Therefore, the present disclosure provides a mechanism that is configured to provide further improved communication quality in a case where a terminal device is connectable to a plurality of wireless communication systems in communication between a plurality of sites.

Note that the above problem or object is merely one of a plurality of problems or objects that can be solved or achieved by a plurality of embodiments disclosed herein.

### Solution to Problem

A control apparatus includes a control unit. The control unit acquires a position of a first communication device and first quality information about communication quality with a plurality of links, from the first communication device being positioned in a first site having a first base station arranged therein to be connected to a first private network, the first communication device being connectable to the plurality of links including the first private network. The control unit acquires a position of a second communication device and second quality information about communication quality with the plurality of links, from the second communication device being positioned in a second site having a second base station arranged therein to be connected to a second private network, the second private network being different from the first private network, the second site being different from the first site, the second communication device being connectable to the plurality of links including the second private network. The control unit acquires first communication information about the first communication device, from the first communication device. The control unit acquires second communication information about the second communication device, from the second communication device. The control unit uses the first communication information, the second communication information, the first quality information, and the second quality information to determine a communication route between the first communication device and the second communication device, the communication route satisfying a desired quality. The control unit notifies the first communication device and the second communication device of route information about the determined communication route.

### BRIEF DESCRIPTION OF DRAWINGS

FIG. 1 is a diagram illustrating an exemplary configuration of a communication system according to an embodiment of the present disclosure.

FIG. 2 is a block diagram illustrating an exemplary configuration of a control apparatus according to an embodiment of the present disclosure.

FIG. 3 is a diagram illustrating an exemplary configuration of a base station according to an embodiment of the present disclosure.

FIG. 4 is a diagram illustrating an exemplary configuration of a terminal device according to an embodiment of the present disclosure.

FIG. 5 is a diagram illustrating an example of coverage of the wireless communication systems according to an embodiment of the present disclosure.

FIG. 6 is a diagram illustrating an example of a backhaul section of the communication system according to an embodiment of the present disclosure.

FIG. 7 is a sequence diagram illustrating an example of a communication route determination process according to an embodiment of the present disclosure.

FIG. 8 is a flowchart illustrating an example of a communication quality measurement process according to an embodiment of the present disclosure.

FIG. 9 is a diagram illustrating an exemplary configuration of a communication system according to a second modification of the embodiment of the present disclosure.

FIG. 10 is a sequence diagram illustrating an example of a communication route determination process according to the second modification of the embodiment of the present disclosure.

FIG. 11 is a diagram illustrating an exemplary configuration of a communication system according to a third modification of the embodiment of the present disclosure.

FIG. 12 is a sequence diagram illustrating an example of a communication route determination process according to the third modification of the embodiment of the present disclosure.

FIG. 13 is a diagram illustrating an exemplary configuration of a communication system according to a fourth modification of the embodiment of the present disclosure.

FIG. 14 is a diagram illustrating an example of route information according to a fifth modification of the embodiment of the present disclosure.

FIG. 15 is a diagram illustrating another example of the route information according to the fifth modification of the embodiment of the present disclosure.

FIG. 16 is a diagram illustrating an example of communication routes according to a sixth modification of the embodiment of the present disclosure.

### DESCRIPTION OF EMBODIMENTS

Embodiments of the present disclosure will be described in detail below with reference to the accompanying drawings. Note that in the present description and the drawings, component elements having substantially the same functional configurations are denoted by the same reference numerals, and redundant descriptions thereof will be omitted.

In addition, in the present description and the drawings, similar component elements of embodiments are distinguished by giving the same reference numerals followed by different alphabets or numerals in some cases. However, when there is no need to particularly distinguish the plurality of similar component elements, the component elements are denoted by the same reference numeral alone.

One or a plurality of embodiments (including examples and modifications) which are described below can be implemented independently. Meanwhile, at least some of the plurality of embodiments described below may be implemented by being appropriately combined with at least some of the other embodiments. The plurality of embodiments can include novel features different from each other. Therefore, the plurality of embodiments can contribute to solving different objects or problems, having different effects.

### 1. INTRODUCTION

### 1.1. Background

As described above, in recent years, the private network has been practically used. In particular, the private network can be established in a predetermined site such as a factory, a business place, or a building. A terminal device in the site is connectable to a plurality of wireless communication systems such as a wireless LAN and a public network in addition to the private network.

In a case where the terminal device is configured to be movable, connectable wireless communication systems are different according to the positions of the terminal device. Furthermore, the wireless communication systems have different communication qualities depending on the position of the terminal device.

Even when the terminal device is fixed, that is, immobile, the communication quality of each wireless communication system may changes depending on a surrounding situation such as the number of terminals connected to the wireless communication system.

In this way, the wireless communication system having good communication quality for the terminal device changes depending on the position of the terminal device, the surrounding situation, the time, and the like.

In the present disclosure, it is assumed that a plurality of sites is provided and the private network is installed in each of the sites. Furthermore, it is assumed that a peer to peer (P2P) connection or a peer to multipeer (P2M) connection is established between a plurality of terminal devices positioned in the plurality of sites.

In this configuration, when each terminal device moves individually or the surrounding situation changes in each site, the communication quality in each site can change and the communication quality between the sites can also change.

Meanwhile, in a predetermined use case, it is required to achieve communication satisfying predetermined required conditions (desired quality) such as security and low latency for data to be transmitted and received.

In a case where the P2P connection or the P2M connection is established between the terminal devices in a plurality of sites, it is important to control the communication quality of E2E communication between the terminal devices in order to achieve the communication satisfying the predetermined required conditions.

The communication quality of E2E communication between the terminal devices is affected by the communication quality in each site and the communication quality between the sites. In order to improve the communication quality of E2E communication between the terminal devices, a mechanism is required to select a more appropriate communication route depending on whether to connect the terminal device to which wireless communication system.

Furthermore, in a predetermined use case, it is required to establish the P2P connection or P2M connection having low latency by using an appropriate communication route (communication parameter).

However, the conventional wireless communication systems have not considered the communication quality of E2E communication between the terminal devices that are connectable to a plurality of networks (links) and positioned in different sites. In addition, it cannot be said that a full consideration is made of a mechanism for establishing the P2P connection or P2M connection having lower latency, in an environment in which a plurality of terminal devices is connectable to a plurality of networks in each of a plurality of sites.

### 1.2. Overview

Therefore, a control apparatus for wireless communication systems according to the present disclosure acquires, from a terminal device positioned in each of a plurality of sites, quality information about the communication qualities of a plurality of networks (links) to which the terminal device is connectable. In addition, the control apparatus acquires terminal information about the terminal device positioned in each of the plurality of sites.

The control apparatus uses the acquired quality information and terminal information to determine the communication route satisfying a desired quality, and notifies the terminal devices in the sites of route information about the determined communication route.

Therefore, it is possible for the control apparatus to select the more appropriate communication route in P2P connection between the terminal devices positioned in different sites, further improving the communication quality of E2E communication between the terminal devices.

### 2. EXEMPLARY CONFIGURATION OF COMMUNICATION SYSTEM

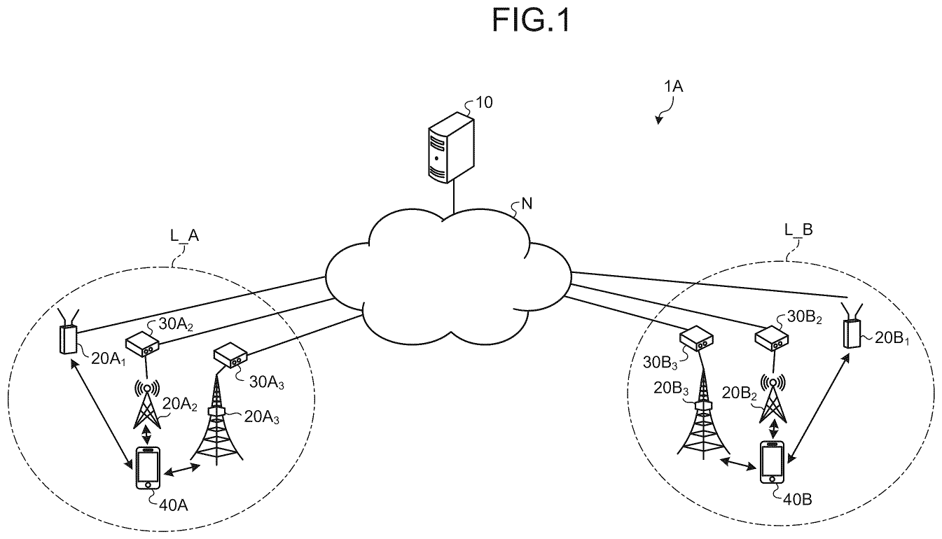

FIG. 1 is a diagram illustrating an exemplary configuration of a communication system 1A according to an embodiment of the present disclosure. As illustrated in FIG. 1, the communication system 1A includes a control apparatus 10, a plurality of base stations 20, a plurality of core networks 30, and a plurality of terminal devices 40.

(Base station 20)

The plurality of base stations 20 are arranged in each of a first site L_A and a second site L_B. In the first site L_A, a plurality of base stations 20A₁ to 20A₃ is arranged. In the second site L_B, a plurality of base stations 20B₁ to 20B₃ is arranged. The plurality of base stations 20A₁ to 20A₃ communicate with the plurality of base stations 20B₁ to 20B₃ via a network N.

In the example of FIG. 1, the base stations 20A₁ and 20B₁ are wireless LAN access points. Furthermore, the base stations 20A₂ and 20B₂ are base stations for a private network (e.g., private LTE/NR), and are connected to the network N via core networks 30A₂ and 30B₂ for the private network. At this time, the core network 30A₂ connected to the base station 20A₂ can be a core network different from the core network 30B₂ connected to the base station 20B₂.

In addition, the base stations 20A₃ and 20B₃ are base stations for a public network (e.g., public LTE/NR), and are connected to the network N via core networks 30A₃ and 30B₃ for the public network. Note that a communication link from each base station 20 to the network N is also referred to as a backhaul link (backhaul section).

Note that in FIG. 1, the core networks 30 are arranged in the sites L, but the present disclosure is not limited thereto. The core networks 30 may be provided at a position other than the sites L. For example, the core networks 30 may be provided on the network N. In addition, FIG. 1 illustrates the core networks 30 implemented by one device (e.g., the information processing apparatus), but the present disclosure is not limited thereto. The core networks 30 may be implemented by a system including a plurality of devices. In addition, the core networks 30A₃ and 30B₃ for the public network can be implemented as one core network. In other words, the base stations 20A₃ and 20B₃ may be connected to the same core network.

As described above, one or more wireless communication systems are installed in each site L. In FIG. 1, three wireless communication systems for the wireless LAN, the private network, and the public network are installed in each the first site L_A and the second site L_B.

In the respective wireless communication systems, one or more base stations 20 are installed in the sites L or around the sites L. The base stations 20 each accommodate one or more terminal devices 40. Each base station 20 performs wireless communication with the accommodated terminal devices 40. The base station 20 is connected to the network N in a wireless or wired manner.

In FIG. 1, three wireless communication systems are installed in each site L, but the present disclosure is not limited thereto. The number of the wireless communication systems arranged in the site L may be two, or four or more. In addition, the number of the wireless communication systems and/or the types of the wireless communication systems to be installed may be different between the first site L_A and the second site L_B.

### (Terminal Device 40)

The plurality of terminal devices 40 are positioned in the first site L_A and the second site L_B, and each communicate with the base stations 20 arranged in each site L. A terminal device 40A is positioned in the first site L_A and is connected to one of the plurality of base stations 20A₁ to 20A₃ arranged in the first site L_A. A terminal device 40B is positioned in the second site L_B and is connected to one of the plurality of base stations 20B₁ to 20B₃ arranged in the second site L_B.

The terminal devices 40A and 40B are connected to one of the plurality of base stations 20, that is, the plurality of networks (links) to perform communication through P2P connection. In this way, the terminal devices 40A and 40B select one of a plurality of communication routes (communication links) and establish the P2P connection.

In FIG. 1, one device 40 is positioned in each site L, but the number of terminal devices 40 is not limited thereto. A plurality of terminal devices 40 may be positioned in each site L.

The terminal devices 40 of the present disclosure are each configured support the plurality of wireless communication systems, for connection to the plurality of base stations 20 in each site L. Each terminal device 40 holds, for example, a subscriber identity module (SIM) card or an embedded subscriber identity module (eSIM) supporting the public network and/or the private network. The terminal device 40 is connected to the public network and the private network through the held SIM card or eSIM.

### (Control Apparatus 10)

The control apparatus 10 is connected to the base stations 20 via the network N. The control apparatus 10 acquires the quality information about the communication quality of each of the wireless communication systems (communication link), from the terminal devices 40. The control apparatus 10 acquires the terminal information about the terminal devices 40 between which P2P connection is established.

The control apparatus 10 determines the communication route on the basis of the acquired quality information and terminal information, and notifies the terminal devices 40 of the route information about the determined communication route.

As described above, a plurality of wireless links and/or backhaul links provided due to the presence of one or more wireless communication systems and base stations 20 (communication nodes) located in each site L of the communication system 1A will provide a plurality of communication routes (communication links). In addition, when considering E2E communication between the terminal devices 40 in different sites L, there is a plurality of communication routes for E2E communication across the sites L. The control apparatus 10 controls a more optimal communication route of the plurality of communication routes. Note that details of a method of controlling the communication route by the control apparatus 10 will be described later.

The control apparatus 10 of the present disclosure controls some or all of one or more wireless communication systems in one or more sites L. In the present disclosure, the control apparatus 10 has at least one of the following functions.
A measurement control function to control measurement of communication quality in each terminal device 40
A communication control function to control (select) the wireless communication systems or base stations 20 used for communication by the terminal devices 40
A DAS function for dynamic spectrum access (DSA)
A core network function corresponding to each core network 30 for each private network

Details of the measurement control function and the communication control function of the above functions will be described later.

Furthermore, the above-described DAS function includes, for example, a function of dynamically or semi-statically controlling a frequency (frequency band) used for communication by at least one of the wireless communication systems, the base stations 20, and the terminal devices 40.

The frequency to be controlled includes a shared spectrum. For example, DSA is performed on the basis of citizens broadband radio service (CBRS), spectrum access system (SAS), licensed shared access (LSA), or the like.

Specifically, in SAS, a management server (e.g., the control apparatus 10) for SAS integrally controls spectrum sharing with users called Tier 2 and Tier 3 so that a priority is given to a user called Tier 1 at a predetermined frequency. Tier 1 is protected from, for example, interference with Tier 2 and Tier 3. A license for the frequency is given to Tier 2 to protect Tier 2 from the use of Tier 3. Tier 2 is also referred to as priority access. No license for the frequency is given to Tier 3, but the frequency is available according to predetermined rules. The predetermined rules define that Tier 3 shall not interfere with Tier 1 and Tier 2 and shall permit interference from Tier 1 and Tier 2. Tier 3 is also referred to as general authorized access.

In addition, in an example of the core network function described above, the control apparatus 10 can be directly connected to each base station 20 in each site L. In another example, the control apparatus 10 supports a control plane (C-Plane) of a core network. In this configuration, a user plane (U-Plane) can be implemented in each core network 30 in each site L.

### DEFINITION OF TERMS

Note that, in the present disclosure, the wireless communication systems (radio access technologies: RATs) may include, for example, various systems as described below.
LTE/NR.
PHS (personal handy-phone system).
sXGP (shared extended Global Platform).
WLAN (wireless LAN, WiFi (registered trademark))
Bluetooth (registered trademark).
DECT (Digital Enhanced Cordless Telecommunications)
MulteFire

In addition, the respective wireless communication systems may be classified into the public network and the private network (non-public network and local network). Note that, in the example of FIG. 1, one public LTE/NR, one private LTE/NR, and one wireless LAN are arranged in each site L, but the present disclosure is not limited thereto. In addition to these RATs, other RATs described above may be arranged. In addition, a plurality of the same RATs may be arranged.

Here, the public network is a network installed and/or operated by a network operator, such as a mobile network operator (MNO) or a mobile virtual network operator (MVNO).

In addition, the private network is a RAT installed in the site L, and can be installed and/or operated by a predetermined operator (business operator). Note that each private network can limit the terminal device 40 to be connected to the private network. In other words, the private network is configured to require permission to connect the terminal device 40 to the private network.

The predetermined operator who installs and/or operates the private network may be, for example, a business operator who owns and/or manages the site L where the private network is installed. In addition, for example, the predetermined operator may be a business operator different from the business operator who owns and/or manages the site L.

In the public network and/or the private network of the present disclosure, a cellular system such as 4G LTE or 5G NR can be used. In the public network and the private network, the core networks 30 (evolved packet core (EPC) in 4G and 5G core (5GC) in 5G) in 5G are installed, and the base stations 20 are connectable to the network N through the core networks 30. Note that, hereinafter, in the present disclosure, the base stations 20 include the core networks 30 unless otherwise specified.

In addition, WLAN can be the public network or the private network. For example, the WLAN in the site L can be installed and/or operated by an operator the same as the operator of the private network (e.g., private LTE/NR) in the same site L. Alternatively, for example, the WLAN in the site L can be installed and/or operated by an operator different from the operator of the private network (e.g., private LTE/NR) in the same site L.

Furthermore, the network N of the present disclosure includes various communication networks such as an internet network, a virtual private network (VPN), a dedicated link, and a satellite communication link.

Furthermore, the backhaul link (backhaul section) of the present disclosure is defined as a communication section of the E2E link from which a fronthaul section (wireless communication section between the terminal devices 40 and the base stations 20) is removed, and can be implemented by a wired line and/or a wireless link.

Note that the backhaul link of the present disclosure can be implemented by various communication links such as direct terminal-to-terminal communication (D2D communication: device-to-device communication), communication via a relay station or relay terminal, and communication via a repeater, in addition to the network N described above.

In addition, the backhaul link can be implemented by a plurality of different communication systems (communication links). For example, the backhaul link can be implemented by a dedicated link and an internet network.

Note that each site L of the present disclosure can be defined as at least one of the followings.
A private network coverage area
A site (or building) owned (or managed) by a predetermined business operator (or government)
An area set in advance by the predetermined business operator or government

For example, in a case where the sites L are each defined as the private network coverage area, a plurality of base stations 20 connected to the same core network 30 may be installed in one site L. In other words, the site L can be defined as the coverage area covered by a plurality of the base stations 20 connected to one core network 30.

In another example, the base stations 20 for the private network, or the core networks 30 have an access point name (APN) that is set for each site L. In other words, in the same site L, the same access point name is set. In this case, for example, a base station 20 having different access point name is recognized that the base station 20 is included in another site L.

Note that the communication routes (communication links) of the present disclosure include one or more wireless communication systems and base stations 20 (communication nodes), the network N, the wireless links and/or the backhaul links, and the like, in the E2E communication between the terminal devices 40.

Here, the communication nodes can also include a relay device to relay a transmission signal between a terminal device 40 and a base station 20 in a wireless link. The relay device includes a repeater, a relay, an intelligent surface (IS), and the like. The relay device can be implemented as a movable device such as the terminal device 40 or as a fixed device such as the base station 20.

Furthermore, the relay device can be controlled by at least one of the control apparatus 10, the wireless communication system, the base station 20, and the terminal device 40. The control includes beam control, power control, and the like suitable for the base station 20 or terminal device 40.

Furthermore, in a case where the relay device is controlled by the control apparatus 10, the control apparatus 10 can determine the communication route in consideration of the beam control or power control for the relay device.

Next, details of the devices included in the communication system 1A will be described.

### 2.1. Exemplary Configuration of Control Apparatus

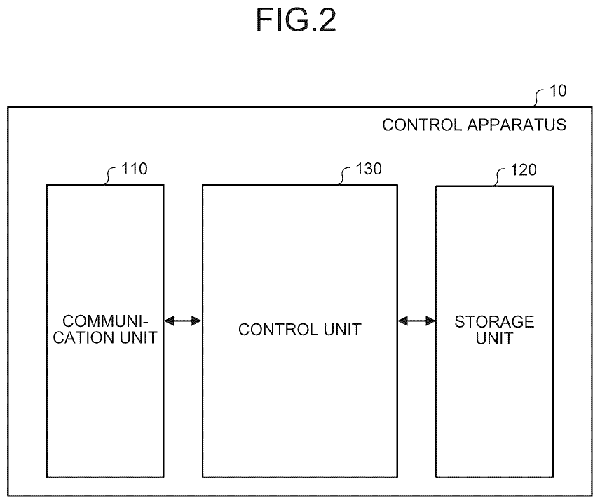

FIG. 2 is a block diagram illustrating an exemplary configuration of the control apparatus 10 according to an embodiment of the present disclosure. The control apparatus 10 is an information processing apparatus that controls the component elements of the communication system 1A.

The control apparatus 10 illustrated in FIG. 2 includes a communication unit 110, a storage unit 120, and a control unit 130. Note that the configuration illustrated in FIG. 2 represents a functional configuration, and the control apparatus 10 may have a hardware configuration different from this functional configuration. Furthermore, the functions of the control apparatus 10 may be distributed, for implementation, in a plurality of physically separated configurations. For example, the control apparatus 10 may be constituted by a plurality of server devices.

### [Communication Unit 110]

The communication unit 110 is a communication interface for communication with another device. The communication unit 210 may be a network interface or a device connection interface. For example, the communication unit 110 may be a local area network (LAN) interface such as a network interface card (NIC) or may be a universal serial bus (USB) interface including a USB host controller, a USB port, and the like. Furthermore, the communication unit 110 may be a wired interface or a wireless interface. The communication unit 110 functions as communication means for the control apparatus 10. The communication unit 110 communicates with the base stations 20 and the terminal devices 40 under the control of the control unit 130.

### [Storage Unit 120]

The storage unit 120 is a data readable/writable storage device such as a dynamic random access memory (DRAM), static random access memory (SRAM), flash memory, or hard disk. The storage unit 120 functions as storage means for the control apparatus 10.

### [Control Unit 130]

The control unit 130 is a controller that controls the units of the control apparatus 10. The control unit 230 is implemented by, for example, a processor such as a central processing unit (CPU), a micro processing unit (MPU), or a graphics processing unit (GPU). For example, the control unit 130 is implemented by executing various programs stored in the storage device in the control apparatus 10 by the processor, with a random access memory (RAM) or the like as a work area. In addition, the control unit 130 may be implemented by an integrated circuit such as an application specific integrated circuit (ASIC) or a field programmable gate array (FPGA). The CPU, MPU, GPU, ASIC, and FPGA can all be regarded as the controllers.

The control unit 130 acquires the quality information and terminal information from the terminal devices 40 to determine the communication route for P2P connection between the terminal devices 40. Details of the operations of the control unit 130 will be described later.

### 2.2. Exemplary Configuration of Base Station

Each of the base stations 20 is a wireless communication device that wirelessly communicates with each of the terminal devices 40. The base station 20 may be configured to wirelessly communicate with the terminal device 40 via a relay station, or may be configured to directly communicate wirelessly with the terminal device 40.

The base station 20 is a type of communication device. More specifically, the base station 20 is a device corresponding to a wireless base station (Node B, eNB, gNB, etc.) or a wireless access point. The base station 20 may be a wireless relay station. Furthermore, the base station 20 may be optical remote radio equipment called remote radio head (RRH) or radio unit (RU). Furthermore, the base station 20 may be a receiving station such as a field pickup unit (FPU). Furthermore, the base station 20 may be an integrated access and backhaul (IAB) donor node or IAB relay node that provides a radio access link and a radio backhaul link by using time division multiplexing, frequency division multiplexing, or space division multiplexing.

Note that radio access technology used by the base station 20 may be a cellular communication technology or a wireless LAN technology. As a matter of course, the radio access technology used by the base station 20 is not limited thereto, and may be another radio access technology. For example, the radio access technology used by the base station 20 may be a low power wide area (LPWA) communication technology. As a matter of course, wireless communication used by the base station 20 may be millimeter wave wireless communication. Furthermore, wireless communication used by the base station 20 may be wireless communication using radio waves, or wireless communication using infrared or visible light (optical wireless communication).

The base station 20 may be configured to perform non-orthogonal multiple access (NOMA) communication with the terminal device 40. Here, NOMA communication is communication using non-orthogonal resources (transmission, reception, or both). Note that the base station 20 may be configured to perform NOMA communication with another base station 20.

Note that the base stations 20 may be communicable with each other via a base station-core network interface (e.g., NG Interface, S1 Interface, etc.). This interface may be a wired interface or a wireless interface. Furthermore, the base stations 20 may be communicable with each other via an inter-base station interface (e.g., Xn interface, X2 interface, S1 interface, F1 interface, etc.). This interface may be a wired interface or a wireless interface.

Note that the concept of the base station includes not only a donor base station but also a relay base station (also referred to as relay station). For example, the relay base station may be any one of an RF repeater, a smart repeater, and an intelligent surface. Furthermore, the concept of the base station includes not only a structure with a function of the base station but also an apparatus installed at the structure.

The structure includes buildings such as a high-rise building, house, steel tower, station facility, airport facility, harbor facility, office building, school building, hospital, factory, commercial facility, and stadium. Note that the concept of the structure includes not only the buildings but also non-building structures such as a tunnel, bridge, dam, fence, and steel column, and facilities such as a crane, gate, and windmill. In addition, the concept of the structure includes not only structures on land (on the ground) or under the ground but also structures on the water such as a pier and megafloat, and structures under the water such as an ocean observation facility. The base station can be also referred to as information processing apparatus.

The base station 20 may be a donor station or a relay station. Furthermore, the base station 20 may be a fixed station or a mobile station. The mobile station is a wireless communication device (e.g., base station) configured to be movable. At this time, the base station 20 may be an apparatus installed in a mobile object or the mobile object itself. For example, a relay station having mobility can be regarded as the base station 20 as the mobile station. In addition, a device, such as a vehicle, unmanned aerial vehicle (UAV) represented by a drone, or smartphone, that originally has mobility and that has functions of the base station (at least some of the functions of the base station) corresponds to the base station 20 as the mobile station, as well.

Here, the mobile object may be a mobile terminal such as a smartphone or mobile phone. Furthermore, the mobile object may be a mobile object (e.g., a vehicle such as an automobile, bicycle, bus, truck, motorcycle, train, or linear motor car) that moves on land (on the ground) or may be a mobile object (e.g., subway) that moves under the ground (e.g., in a tunnel).

Furthermore, the mobile object may be a mobile object (e.g., a ship such as a passenger ship, cargo ship, or hovercraft) that moves on the water or may be a mobile object (e.g., a submersible ship such as a submersible vessel, submarine boat, or unmanned submersible) that moves under water.

Note that the mobile object may be a mobile object (e.g., aircraft such as airplane, airship, or drone) that moves in the atmosphere.

Furthermore, the base station 20 may be a terrestrial base station (ground station) that is installed on the ground. For example, the base station 20 may be a base station that is arranged in a structure on the ground or a base station that is installed in a mobile object moving on the ground. More specifically, the base station 20 may be an antenna that is installed on a structure such as a building and a signal processing device connected to the antenna. As a matter of course, the base station 20 may be the structure itself or mobile object itself. “On the ground” represents not only on land (on the ground) but also under the ground, on the water, and under the water in a broad sense. Note that the base station 20 is not limited to the terrestrial base station. For example, in a case where the communication system 1 is a satellite communication system, the base station 20 may be an aeronautical station. From the viewpoint of a satellite station, an aeronautical station positioned on the earth is a ground station.

Note that the base station 20 is not limited to the ground station. The base station 20 may be a non-terrestrial base station (non-ground station) that is configured to float in the air or in space. For example, the base station 20 may be an aeronautical station or a satellite station.

The satellite station is a satellite station that is configured to float above the atmosphere. The satellite station may be an apparatus mounted in a space vehicle such as an artificial satellite or may be the space vehicle itself. The space vehicle is a mobile object that moves above the atmosphere. Examples of the space vehicle include artificial celestial bodies such as an artificial satellite, spacecraft, space station, and probe.

A satellite serving as the satellite station may be any of a low earth orbiting (LEO) satellite, a medium earth orbiting (MEO) satellite, a geostationary earth orbiting (GEO) satellite, and a highly elliptical orbiting (HEO) satellite. As a matter of course, the satellite station may be an apparatus mounted in the low earth orbiting satellite, medium earth orbiting satellite, geostationary earth orbiting satellite, or highly elliptical orbiting satellite.

The aeronautical station is a wireless communication device that is configured to float in the atmosphere, such as an aircraft. The aeronautical station may be an apparatus mounted in an aircraft or the like or may be the aircraft itself. Note that the concept of the aircraft includes not only a heavier-than-air aircraft such as an airplane or glider, but also a lighter-than-air aircraft such as a balloon or airship. Furthermore, the concept of the aircraft includes not only the heavier-than-air aircraft or lighter-than-air aircraft, but also a rotorcraft such as a helicopter or autogiro. Note that the aeronautical station (or an aircraft in which the aeronautical station is mounted) may include an unmanned aircraft such as a drone.

Note that the concept of the unmanned aircraft also includes unmanned aircraft systems (UAS) and tethered UAS. Furthermore, the concept of the unmanned aircraft includes a lighter than air UAS (LTA) and a heavier than air UAS (HTA). In addition, the concept of the unmanned aircraft also includes high altitude UAS platforms (HAPs).

The base station 20 may provide large coverage, such as a macrocell, or small coverage, such as a picocell. As a matter of course, the base station 20 may provide extremely small coverage, such as a femtocell. Furthermore, the base station 20 may have beamforming capability. In this case, a cell or service area may be formed for each beam, in the base station 20.

Furthermore, in some embodiments, the concept of the base station may include a set of a plurality of physical or logical devices. For example, in the present embodiment, the base station may be divided into a plurality of devices, such as a baseband unit (BBU) and a radio unit (RU). Then, the base station may be interpreted as an assembly of the plurality of devices. In addition, the base station may be either or both of the BBU and the RU. The BBU and the RU may be connected via a predetermined interface (e.g., enhanced common public radio interface (eCPRI)). Note that the RU may be referred to as remote radio unit (RRU) or radio DoT (RD). Furthermore, the RU may correspond to a gNB distributed unit (gNB-DU) which is described later. Furthermore, the BBU may correspond to a gNB central unit (gNB-CU) which is described later. Alternatively, the RU may be a wireless device connected to the gNB-DU which is described later. The gNB-CU, the gNB-DU, and the RU connected to the gNB-DU may be configured according to an open radio access network (O-RAN). Furthermore, the RU may be a device integrally formed with an antenna. The base station has an antenna (e.g., the antenna integrally formed with the RU), and the antenna may adopt advanced antenna system to support MIMO (e.g., FD-MIMO) or beamforming. Furthermore, the antenna of the base station may include, for example, 64 transmission antenna ports and 64 reception antenna ports.

In addition, the antenna mounted in the RU may be an antenna panel that includes one or more antenna elements, and the RU may include one or more antenna panels. For example, the RU may include two types of antenna panels of a horizontally polarized antenna panel and a vertically polarized antenna panel, or two types of antenna panels of a right-hand circular polarization antenna panel and a left-hand circular polarization antenna panel. In addition, the RU may form and control an independent beam for each antenna panel.

Note that a plurality of the base stations may be connected to each other. One or more base stations may be included in a radio access network (RAN). In this configuration, each of the base stations may be simply referred to as RAN, a RAN node, access network (AN), or an AN node. Note that RAN in LTE is referred to as enhanced universal terrestrial RAN (EUTRAN), in some cases. Furthermore, RAN in NR is referred to as NGRAN, in some cases. Furthermore, RAN in W-CDMA (UMTS) is referred to as UTRAN, in some cases.

Note that a base station for LTE may be referred to as evolved node B (eNodeB) or eNB. At this time, EUTRAN includes one or more eNodeBs (eNBs). Furthermore, a base station for NR may be referred to as gNodeB or gNB. At this time, NGRAN includes one or more gNBs. EUTRAN may include gNB (en-gNB) that is connected to a core network (EPC) in an LTE communication system (EPS). Likewise, NGRAN may include ng-eNB that is connected to a core network 5GC in a 5G communication system (5GS).

Note that in a case where the base station is eNB, gNB, or the like, the base station may be referred to as 3GPP access. Furthermore, in a case where the base station is a wireless access point, the base station may be referred to as non-3GPP access. Furthermore, the base station may be optical remote radio equipment called remote radio head (RRH) or radio unit (RU). Furthermore, in a case where the base station is gNB, the base station may have a combination of gNB-CU and gNB-DU which has been described above, or may be any one of the gNB-CU and the gNB-DU.

Here, the gNB-CU hosts a plurality of upper layers (e.g., radio resource control (RRC), service data adaptation protocol (SDAP), and packet data convergence protocol (PDCP)) of an access stratum, for communication with UE. Meanwhile, the gNB-DU hosts a plurality of lower layers (e.g., radio link control (RLC), medium access control (MAC), and physical layer (PHY)) of the access stratum. In other words, of messages/pieces of information which is described later, RRC signaling (semi-static notification) may be generated by the gNB CU, and MAC CE or DCI (dynamic notification) may be generated by the gNB-DU. Alternatively, of RRC configurations (semi-static notification), for example, some configurations such as IE: cellGroupConfig may be generated by the gNB-DU, and the rest of the configurations may be generated by the gNB-CU. These configurations may be transmitted and received through an F1 interface which is described later.

Note that the base station may be configured to be communicable with another base station. For example, in a case where a plurality of base stations is eNBs or has a combination of eNB and en-gNB, the base stations may be connected via an X2 interface. Furthermore, in a case where a plurality of base stations is gNBs or has a combination of gn-eNB and gNB, the devices may be connected via an Xn interface. Furthermore, in a case where a plurality of base stations has a combination of gNB-CU and gNB-DU, the devices may be connected via the F1 interface. A message/information (e.g., RRC signaling, MAC Control Element (MAC CE), or DCI) which is described later may be transmitted between the plurality of base stations, for example, via the X2 interface, Xn interface, or F1 interface.

A cell provided by the base station is referred to as serving cell, in some cases. The concept of the serving cell includes a primary cell (PCell) and a secondary cell (SCell). In a case where dual connectivity is set for UE (e.g., terminal device 40), the PCell and zero or more SCells that are provided by a master node (MN) is referred to as a master cell group, in some cases. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity.

Note that the serving cell may include PSCell (primary secondary cell or primary SCG cell). In a case where the dual connectivity is set for UE, PSCell and zero or more SCells provided by secondary node (SN) is referred to as secondary cell group (SCG), in some cases. Unless otherwise especially set (e.g., PUCCH on SCell), the physical uplink control channel (PUCCH) is transmitted in the PCell and PSCell, but is not transmitted in the SCell. Furthermore, radio link failure is also detected in the PCell and the PSCell, but is not detected (may not be detected) in the SCell. In this way, the PCell and the PSCell that have special roles in the serving cell are also referred to as special cell (SpCell).

One downlink component carrier and one uplink component carrier may be associated with one cell. Furthermore, a system bandwidth corresponding to one cell may be divided into a plurality of bandwidth parts (BWPs). In this configuration, one or more BWPs may be set to UE and one of the BWPs may be used for the UE, as active BWP. In addition, radio resources (e.g., frequency band, numerology (subcarrier spacing), and a slot format (slot configuration)) that can be used by the terminal device 40 may be different between cells, component carriers, or BWPs.

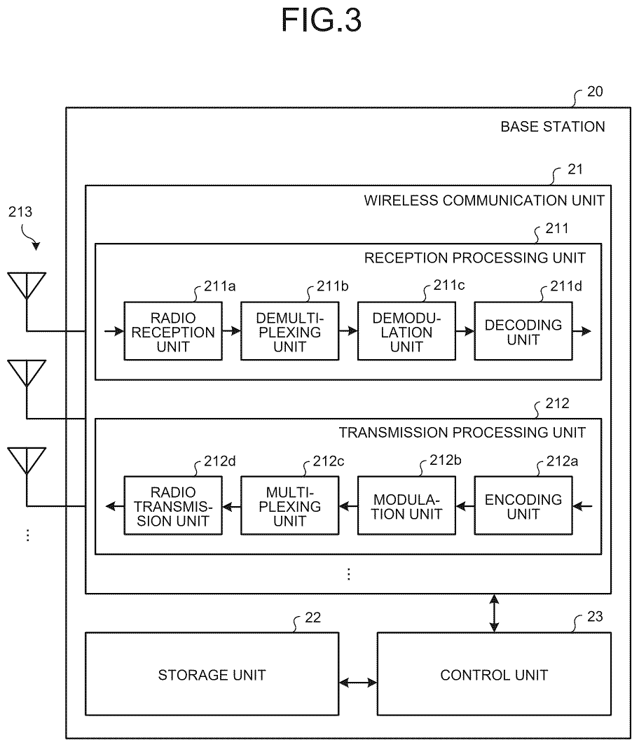

FIG. 3 is a diagram illustrating an exemplary configuration of the base station 20 according to an embodiment of the present disclosure. The base station 20 includes a wireless communication unit 21, a storage unit 22, and a control unit 23. Note that the configuration illustrated in FIG. 3 represents a functional configuration, and the base station 20 may have a hardware configuration different from this functional configuration. Furthermore, the functions of the base station 20 may be distributed, for implementation, to a plurality of physically separated configurations.

### (Wireless Communication Unit 21)

The wireless communication unit 21 is a signal processing unit for wireless communication with another wireless communication device (e.g., terminal device 40). The wireless communication unit 21 operates under the control of the control unit 23. The wireless communication unit 21 supports one or more radio access systems. For example, the wireless communication unit 21 supports both of NR and LTE. The wireless communication unit 21 may support W-CDMA or cdma2000 in addition to NR and LTE.

The wireless communication unit 21 includes a transmission processing unit 211, a reception processing unit 212, and an antenna 213. The wireless communication unit 21 may include a plurality of the transmission processing units 211, reception processing units 212, and antennas 213. Note that in a case where the wireless communication unit 21 supports a plurality of radio access systems, the units of the wireless communication unit 21 can be individually configured for each of the radio access systems. For example, the transmission processing unit 211 and the reception processing unit 212 may be configured individually for each of LTE and NR. Furthermore, the antenna 213 may include a plurality of antenna elements (e.g., a plurality of patch antennas). In this configuration, the wireless communication unit 21 may be configured to perform beamforming. The wireless communication unit 21 may be configured to perform polarization beamforming by using vertical polarization (V polarization) and horizontal polarization (H polarization).

The transmission processing unit 211 performs transmission processing for downlink control information and downlink data. For example, the transmission processing unit 211 encodes the downlink control information and the downlink data that are input from the control unit 23, by using an encoding method such as block coding, convolutional coding, or turbo coding. Note that, as the encoding, polar code encoding and low density parity check code (LDPC) encoding may be performed. The transmission processing unit 211 modulates encoded bits by a predetermined modulation method such as BPSK, QPSK, 16QAM, 64QAM, or 256QAM. Then the transmission processing unit 211 multiplexes a modulation symbol and a downlink reference signal on each channel so as to be allocated to a predetermined resource element. Then the transmission processing unit 211 performs various types of signal processing on a signal obtained by multiplexing. For example, the transmission processing unit 211 performs processing, such as conversion to a frequency domain by using fast Fourier transform, addition of a guard interval (cyclic prefix), generation of a baseband digital signal, conversion to an analog signal, quadrature modulation, up-convert, removal of an unnecessary frequency component, and amplification of power. The signal generated by the transmission processing unit 211 is transmitted from the antenna 213.

The reception processing unit 212 processes an uplink signal received via the antenna 213. For example, the reception processing unit 212 performs, on the uplink signal, down-convert, removal of an unnecessary frequency component, control of an amplification level, quadrature demodulation, conversion to a digital signal, removal of a guard interval (cyclic prefix), extraction of a frequency domain signal by using fast Fourier transform, and the like. Then the reception processing unit 212 demultiplexes an uplink channel, such as a physical uplink shared channel (PUSCH) or a physical uplink control channel (PUCCH), and an uplink reference signal, from the signal on which the processing has been performed. Furthermore, the reception processing unit 212 uses a modulation method such as binary phase shift keying (BPSK) or quadrature phase shift keying (QPSK) for a modulation symbol on the uplink channel to demodulate the received signal. The modulation method used for the demodulation may be 16 quadrature amplitude modulation (QAM), 64QAM, or 256QAM. Then the reception processing unit 212 performs decode processing on the demodulated encoded bits on the uplink channel. Uplink data and uplink control information that have been decoded are output to the control unit 23.

The antenna 213 is an antenna device (antenna unit) that mutually converts a current and a radio wave. The antenna 213 may include one antenna element (e.g., one patch antenna) or may include a plurality of the antenna elements (e.g., a plurality of the patch antennas). In a case where the antenna 213 includes the plurality of the antenna elements, the wireless communication unit 21 may be configured to perform beamforming. For example, the wireless communication unit 21 may be configured to use the plurality of the antenna elements to control the directivity of a radio signal and generate a directional beam. Note that the antenna 213 may be a dual-polarized antenna. In a case where the antenna 213 is the dual-polarized antenna, the wireless communication unit 21 may use the vertical polarization (V polarization) and the horizontal polarization (H polarization), for transmission of the radio signal. Then, the wireless communication unit 21 may control the directivity of the radio signal transmitted using the vertical polarization and the horizontal polarization. Furthermore, the wireless communication unit 21 may transmit and receive spatially multiplexed signals via a plurality of layers of a plurality of antenna elements.

### (Storage Unit 22)

The storage unit 22 is a data readable/writable storage device such as DRAM, SRAM, a flash memory, or a hard disk. The storage unit 22 functions as storage means for the base station 20.

### (Control Unit 23)

The control unit 23 is a controller that controls the units of the base station 20. The control unit 23 is implemented by a processor such as a central processing unit (CPU) or a micro processing unit (MPU). For example, the control unit 23 is implemented by executing various programs stored in the storage device in the base station 20 by the processor, with a random access memory (RAM) or the like as a work area. Note that the control unit 23 may be implemented by an integrated circuit such as an application specific integrated circuit (ASIC) or a field programmable gate array (FPGA). The CPU, MPU, ASIC, and FPGA can all be regarded as the controllers. Furthermore, the control unit 23 may be implemented by a graphics processing unit (GPU) in addition to or instead of the CPU.

### 2.3. Exemplary Configuration of Terminal Device

The terminal device 40 is a wireless communication device that wirelessly communicates with another communication device such as the base station 20 or the like. The terminal device 40 is, for example, a mobile phone, smart device (smartphone or tablet), personal digital assistant (PDA), or personal computer. Furthermore, the terminal device 40 may be a device, such as a business camera, provided with a communication function, or may be a motorcycle, a moving relay vehicle, or the like on which a communication device such as a field pickup unit (FPU) is mounted. Furthermore, the terminal device 40 may be a machine to machine (M2M) device or an Internet of things (IoT) device. Furthermore, the terminal device 40 may be a device that has a relay function and is connectable to a wearable device.

Note that the terminal device 40 may be configured to perform NOMA communication with the base station 20. Furthermore, the terminal device 40 may be configured to use an automatic retransmission technology such as HARQ upon communication with the base station 20. Furthermore, the terminal device 40 may be configured to perform sidelink communication with another terminal device 40. The terminal device 40 may be configured to use the automatic retransmission technology such as HARQ upon the sidelink communication. Note that the terminal device 40 may be configured to perform NOMA communication also in communication (sidelink) with another terminal device 40. Furthermore, the terminal device 40 may be configured to perform LPWA communication with other communication devices (e.g., the base station 20 and the another terminal device 40). In addition, wireless communication used by the terminal device 40 may be millimeter wave wireless communication. Note that wireless communication (including sidelink communication) used by the terminal device 40 may be wireless communication using radio waves or wireless communication using infrared or visible light (optical wireless communication).

Furthermore, the terminal device 40 may be a mobile device. Here, the mobile device is a movable wireless communication device. Furthermore, the terminal device 40 may be a wireless communication device installed in a mobile object or the mobile object itself. For example, the terminal device 40 may be a vehicle, such as an automobile, bus, truck, or motorcycle, that moves on a road or may be a vehicle, such as train, that moves on rail tracks, or may be a wireless communication device mounted on such vehicles. Note that the mobile object may be a mobile terminal, or may be a mobile object that moves on land (on the ground), under the ground, on the water, or under the water. Furthermore, the mobile object may be a mobile object that moves in the atmosphere, such as a drone or a helicopter, or may be a mobile object that moves above the atmosphere, such as an artificial satellite.

The terminal device 40 may be simultaneously connected to a plurality of base stations 20 or a plurality of cells, for communication. For example, in a case where one base station 20 supports a communication area via a plurality of cells (e.g., pCell and sCell), it is possible to combine the plurality of cells by a carrier aggregation (CA) technology, a dual connectivity (DC) technology, or a multi-connectivity (MC) technology, enabling communication between the base station 20 and the terminal devices 40. Alternatively, it is also possible for the terminal device 40 and a plurality of different base stations 20 to perform communication with each other via cells of the base stations 20 by using a coordinated multi-point transmission and reception (COMP) technology.

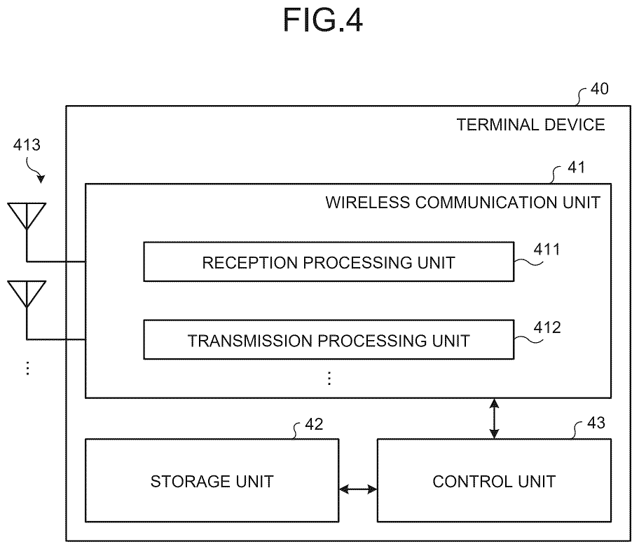

FIG. 4 is a diagram illustrating an exemplary configuration of the terminal device 40 according to an embodiment of the present disclosure. The terminal device 40 includes a wireless communication unit 41, a storage unit 42, and a control unit 43. Note that the configuration illustrated in FIG. 4 represents a functional configuration, and the terminal device 40 may have a hardware configuration different from this functional configuration. Furthermore, the functions of the terminal device 40 may be distributed, for implementation, in a plurality of physically separated configurations.

### (Wireless Communication Unit 41)

The wireless communication unit 41 is a signal processing unit for wireless communication with other wireless communication devices (e.g., the base station 20 and another terminal device 40). The wireless communication unit 41 operates under the control of the control unit 43. The wireless communication unit 41 includes a transmission processing unit 411, a reception processing unit 412, and an antenna 413. The configurations of the wireless communication unit 41, the transmission processing unit 411, the reception processing unit 412, and the antenna 413 may be similar to those of the wireless communication unit 21, the transmission processing unit 211, the reception processing unit 212, and the antenna 213 of the base station 20. Furthermore, the wireless communication unit 41 may be configured to perform beamforming, as in the wireless communication unit 21. Furthermore, the wireless communication unit 41 may be configured to transmit and receive spatially multiplexed signals, as in the wireless communication unit 21.

### (Storage Unit 42)

The storage unit 42 is a data readable/writable storage device such as DRAM, SRAM, a flash memory, or a hard disk. The storage unit 42 functions as storage means for the terminal device 40.

### (Control Unit 43)

The control unit 43 is a controller that controls the units of the terminal device 40. The control unit 43 is implemented by a processor such as CPU or MPU. For example, the control unit 43 is implemented by executing various programs stored in the storage device in the terminal device 40 by the processor, with RAM or the like as a work area. Note that the control unit 43 may be implemented by an integrated circuit such as ASIC or FPGA. The CPU, MPU, ASIC, and FPGA can all be regarded as the controllers. Furthermore, the control unit 43 may be implemented by GPU in addition to or instead of the CPU.

### 3. OPERATION EXAMPLES OF COMMUNICATION SYSTEM

As described above, the control apparatus 10 acquires the quality information about each of the wireless communication systems (communication link), from the terminal devices 40. Next, the control apparatus 10 determines the communication route for the terminal devices 40 on the basis of the quality information.

Therefore, in the embodiment of the present disclosure, first, a method of determining (controlling) the communication route by the control apparatus 10 will be described, and next, an acquisition method for acquiring the quality information will be described.

### 3.1. Method of Controlling Communication Route

In the embodiment of the present disclosure, the terminal device 40A (hereinafter, also described as first terminal device 40A) in the first site L_A performs P2P communication with the terminal device 40B (hereinafter, also described as second terminal device 40B) in the second site L_B. In the P2P communication, the control apparatus 10 performs a control method of controlling (selecting) the communication route having a more appropriate communication quality in E2E.

Here, in the embodiment of the present disclosure, the communication quality can be represented by using various indexes. The communication quality differs depending on various elements such as the position of each terminal device 40 and RAT or the base station 20 to which the terminal device 40 is connected. Furthermore, the communication quality can be considered separately for the wireless section and the backhaul section.

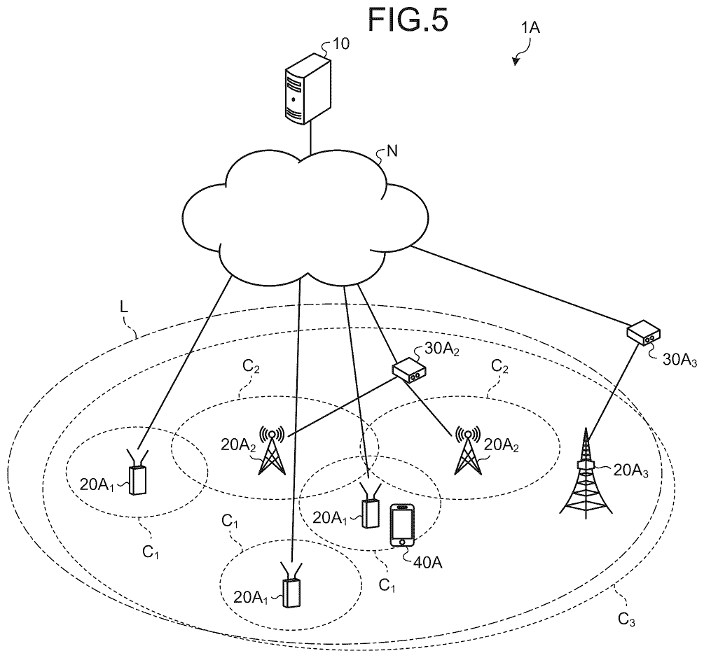

FIG. 5 is a diagram illustrating an example of the coverage of the wireless communication systems according to an embodiment of the present disclosure. FIG. 5 illustrates the site L_A of the plurality of sites L_A and L_B, but the same applies to the site L_B. The site L_A can be set, for example, according to communication areas of the base stations 20.

In the example of FIG. 5, three base stations 20A₁, which are the wireless LAN access points, are arranged in the site L_A. Each base station 20A₁ has a communication area (coverage) C₁. In FIG. 5, each base station 20A₁ has a communication area C₁ positioned in the site L_A.

In addition, in the example of FIG. 5, two base stations 20A₂, which are base stations for private LTE/NR, are arranged in the site L_A. Each base station 20A₂ has a communication area C₂. In FIG. 5, the communication area C₂ of each base station 20A₂ is larger than the communication area C₁ of each base station 20A₁. In addition, the communication area C₂ of each base station 20A₂ is positioned in the site L_A. The communication areas C₂ of the base stations 20A₂ partially overlap each other. The communication areas C₂ of the base stations 20A₂ partially overlap the communication areas C₁ of the base stations 20A₁.

In the example of FIG. 5, one base station 20A₃, which is the base station for public LTE/NR, is arranged in the site L_A. The base station 20A₃ has a communication area C₃. In FIG. 5, the communication area C₃ of the base station 20A₃ is larger than the communication areas C₂ of the base stations 20A₂. In addition, the communication area C₃ of the base station 20A₃ partially overlaps with the site L_A.

In this way, the wireless communication systems (RAT) or the base stations 20 have different communication areas C depending on the performance of the RAT or base station, a legal rule, or the like.

Therefore, different RATs allow the communication of the terminal device 40, depending on the position of the terminal device 40. The communication quality of the terminal device depends on the performance of RAT or the like. Furthermore, a propagation path characteristic is different between the terminal device 40 and each base station 20 depending on the distance or the like between the terminal device 40 and the base station 20, affecting the communication quality of the terminal device 40. In other words, the communication quality of the terminal device 40 is affected by the RATs to which the terminal device 40 is connected and the distances to the base stations 20. Note that the position of the terminal device 40 here may be either an absolute position, or a relative position with respect to each base station.

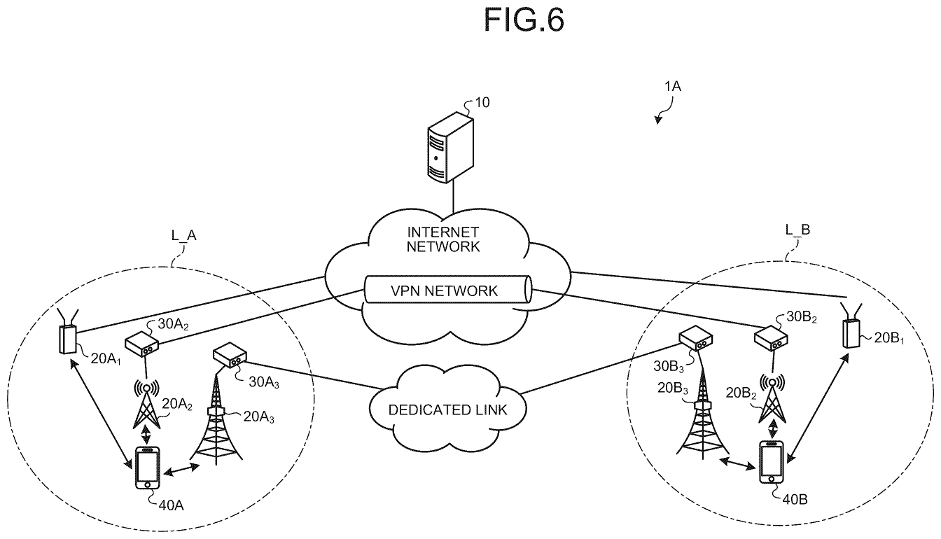

FIG. 6 is a diagram illustrating an example of the backhaul section of the communication system 1A according to an embodiment of the present disclosure.

In the example of FIG. 6, the base stations 20A₁ and 20B₁, which are the wireless LAN acceleration points, are connected to each other via the internet network. Furthermore, the base stations 20A₂ and 20B₂, which are base stations of the private LTE/NR, are connected to each other via the virtual private network (VPN). The base stations 20A₃ and 20B₃, which are the base stations for public LTE/NR, are connected to each other via the dedicated link.

In this way, when the wireless LAN is connected to the internet network, the communication quality thereof in the backhaul section is determined depending on the communication quality of the internet network. When the private LTE/NR is connected to the VPN, the communication quality thereof in the backhaul section is determined depending on the communication quality of the VPN. In particular, high security is promising in communication through VPN.

Furthermore, in a case where the public LTE/NR is connected to the dedicated link, the communication quality thereof in the backhaul section is determined depending on the communication quality of the dedicated link. In particular, the communication through the dedicated link can effectively control the communication quality without being affected by other networks.

### (Communication Route Determination Process)

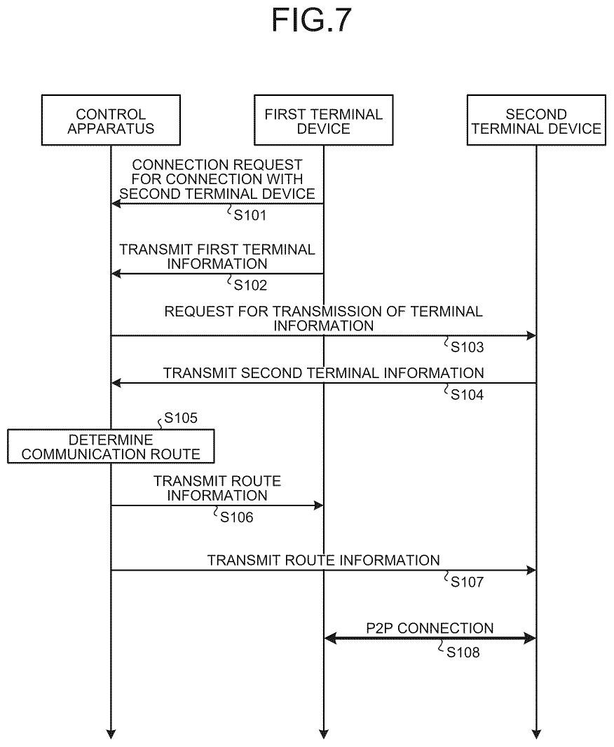

FIG. 7 is a sequence diagram illustrating an example of a communication route determination process according to an embodiment of the present disclosure.

As illustrated in FIG. 7, the first terminal device 40A transmits a connection request for connection with the second terminal device 40B to the control apparatus 10 (Step S101). In addition, the first terminal device 40A transmits first terminal information that is terminal information about the first terminal device 40A, to the control apparatus 10 (Step S102).

The control apparatus 10 having received the connection request from the first terminal device 40A requests the second terminal device 40B to transmit terminal information (Step S103). The second terminal device 40B transmits second terminal information that is terminal information about the second terminal device 40B, to the control apparatus 10 (Step S104).

The control apparatus 10 determines the communication route by using the acquired quality information from the first and second terminal devices 40A and 40B and the acquired terminal information about the first and second terminal devices 40A and 40B (Step S105).

The control apparatus 10 transmits the route information about the determined communication route to the first terminal device 40A (Step S106). In addition, the control apparatus 10 transmits the route information to the second terminal device 40B (Step S107). The first and second terminal devices 40A and 40B establishes P2P connection by using the acquired route information (Step S108).

### (Connection Request)

Here, in Step S101 of FIG. 7, the first terminal device 40A requests the P2P connection with the second terminal device 40B, from the control apparatus 10. At this time, the first terminal device 40A can transmit information for identifying the second terminal device 40B. The information for identifying the second terminal device 40B can include, for example, information for identifying the terminal device 40 which is described later, and information indicating the second site L_B where the second terminal device 40B is positioned.

Note that the first terminal device 40A may transmit, as the information for identifying the second terminal device 40B, information indicating the second site L_B, instead of the information for identifying the terminal device 40 which is described later. In this case, the first terminal device 40A establishes the P2P connection with a predetermined terminal device 40 in the second site L_B. In other words, the second site L_B and the predetermined terminal device 40 that establishes the P2P connection with the first terminal device 40A are associated with each other in advance.

Furthermore, the first terminal device 40A may give notice of the quality information which is described later, in addition to the connection request.

### (Terminal Information)

In Step S102 of the determination process described above, the first terminal device 40A transmits the terminal information to the control apparatus 10. In Step S104, the second terminal device 40B transmits the terminal information to the control apparatus 10.

The terminal information includes information specific to each terminal device 40. The terminal information is information used by the control apparatus 10 to determine the more appropriate communication route. For example, the terminal information includes the following information.
Information for identifying the terminal device 40
Position information of the terminal device 40
Capability information of the terminal device 40
Information indicating a condition of the terminal device 40

### (Information for Identifying Terminal Device 40)

The information for identifying each terminal device 40 includes the following information.
Terminal ID uniquely assigned in each site L
Terminal ID globally and uniquely assigned
Terminal ID uniquely assigned across sites L having possibility of connection
ID unique to a SIM card used by the terminal device 40.
An Internet protocol (IP) address assigned to the terminal device 40
Media access control (MAC) address of the terminal device 40
ID assigned upon manufacturing the terminal device 40
ID determined by an operating system (OS) used by the terminal device 40

Note that examples of the ID unique to a SIM card used by each terminal device 40 include an international mobile subscriber identity (IMSI), a telephone number, and the like.

### (Position Information of Terminal Device 40)

The position information of each terminal device 40 includes the following information.
Absolute position information
Relative position information
Information about a country, a district, and an area
Information indicating the site L
Information indicating an area (e.g., each communication area C) in the site L

Note that examples of the absolute position information include latitude, longitude, altitude, and the like. Examples of the relative position information include a distance and direction from a predetermined base station 20, a distance and direction from a predetermined reference point, and the like.

The position information of the terminal device 40 can be acquired by various methods using a global positioning system (GPS), global navigation satellite system (GNSS), Bluetooth beacon, ultra wideband (UWB) beacon, LTE/NR, wireless LAN, and the like. For example, a predetermined signal can be transmitted from a plurality of transmission apparatuses (the base stations 20, etc.) so that the terminal device 40 receives the predetermined signal to acquire the position information, from a difference in arrival time of the predetermined signal, or the like. Furthermore, for example, the terminal device 40 can transmit a predetermined signal so that a plurality of reception apparatuses (the base stations 20, etc.) receives the predetermined signal to acquire the position information from a difference in arrival time of the predetermined signal, or the like.

Furthermore, predetermined position information can be set in the terminal device 40 in advance. The predetermined position information that can be set in advance includes, for example, the information about a country, a district, and an area, the information indicating the site L, and the like.

Furthermore, the position information of the present disclosure may be not only information explicitly indicating a position such as latitude and longitude, but also information implicitly (indirectly) indicating a position. For example, a plurality of beacon terminals (e.g., Bluetooth beacons or UWB beacons) can be installed in a predetermined area so that received power (RSRP) acquired on the basis of signals transmitted from the beacon terminals is used as implicit position information. More specifically, a list of received power that the terminal device 40 can acquire from the beacon terminals depending on the position of the terminal device 40 in the predetermined area is used as the position information. This configuration does not require acquisition of the explicit position information such as latitude and longitude, and is a preferable method particularly to an indoor space where it is difficult to receive a GPS signal. Furthermore, in another specific example, the closest beacon terminal (the beacon terminal that provides the highest received power) may be used as the implicit position information.

Furthermore, the terminal device 40 may be configured to transmit information (reliability information) indicating the accuracy (reliability) of the position information, added to the position information. The information indicating the accuracy of the position information can be acquired on the basis of the maximum value, average value, or the like of an error in estimated distance. The control apparatus 10 is configured to perform control for determination of the communication route or the like, in consideration of the accuracy of the position information.

Furthermore, the terminal device 40 may be configured to transmit information (acquisition information) indicating an acquisition method for the position information, added to the position information. For example, the information indicating an acquisition method for the position information is obtained on the basis of information indicating the system such as GPS, GNSS, Bluetooth beacon, UWB beacon, LTE/NR, or wireless LAN. The control apparatus 10 is configured to perform control for determination of the communication route or the like, in consideration of the acquisition method for the position information.

### (Capability Information of Terminal Device 40)

The capability information of each terminal device 40 is, for example, information indicating a function supported by the terminal device 40 or capability thereof. The capability information of the terminal device 40 includes the following information.
RAT supported
Maximum transmission power
Information about transmission antenna/reception antenna
Signal processing capability of the terminal device 40
A time period required for switching communication link

Examples of the RAT supported include a cellular network (public network/private network)/WLAN and the like.

Furthermore, in a case where the RAT supported is the cellular network, the following information can be included as the capability information.
RAT supported (3G/4G/5G/6G)
Release supported (Release-8/9, etc.)
Connectable network (network operator and APN)
Frequency band supported

In addition, in a case where the RAT supported is WLAN, the following information can be included as the capability information.
Standards supported (802.11 a/b/n/ax/ay and WiFi 4/5/6)
Frequency band supported

Furthermore, examples of the signal processing capability of the terminal device 40 include a processing speed and the like in an application layer.

### (Information Indicating Condition of Terminal Device 40)

The information indicating the condition of each terminal device 40 includes information that is changeable in a short time and information that does not change in a short time.

The information that is changeable in a short time includes, for example, a battery level, whether the terminal device 40 is being charged, and the like. Furthermore, the information that is changeable in a short time includes, for example, a moving speed of the terminal device 40, a moving direction of the terminal device 40, a destination of the terminal device 40 moving, a moving route of the terminal device 40 moving, and the like. The information that is changeable in a short time includes the temperature of the terminal device 40, an operating time of the terminal device 40, and the like.

The information that does not change in a short time includes, for example, a user of the terminal device 40 (person, machine, etc.), whether the terminal device 40 is movable or fixed, and a movement range of the movable terminal device 40. Furthermore, the information that does not change in a short time includes, for example, information about the communication cost of the terminal device 40 (packet measured rate and packet flat rate), and the like.

Note that some pieces of the terminal information described above can be held by the control apparatus 10 in advance. For example, of the terminal information described above, the information that does not change in a short period of time can be held in the control apparatus 10 in advance.

Specifically, the control apparatus 10 can hold some pieces of the terminal information in association with the information for identifying each terminal device 40, in the terminal device 40 or in a database to which the control apparatus 10 is accessible. Examples of some pieces of terminal information that can be held by the control apparatus 10 in advance include the capability information of the terminal device 40, information that does not change in a short time of the information indicating the condition of the terminal device 40, information about the site L in which the terminal device 40 is positioned, and the like.

Note that the terminal device 40 is configured to transmit the required conditions in P2P communication (P2P connection) which is described later in addition to the terminal information, to the control apparatus 10. Note that the required conditions may be notified for each P2P connection or may be notified for each type of data to be transmitted and received.

### (Determination of Communication Route)

In Step S105 of the determination process described above, the control apparatus 10 determines the communication route. The control apparatus 10 determines an optimal communication route between the first terminal device 40A and the second terminal device 40B on the basis of the terminal information received and the information held in advance. Note that the information held in advance includes the quality information. Details of the quality information will be described later.

For example, a method of determining the optimal communication route is as follows.

First, the control apparatus 10 holds communication quality information and the like corresponding to the position information of each terminal device 40 in advance. Therefore, the control apparatus 10 determines the more appropriate communication route between the first terminal device 40A and the second terminal device 40B, with the position information received.

Note that the more appropriate communication route can be determined on the basis of the required conditions (desired quality) in the P2P communication (P2P connection). The control apparatus 10 determines the more appropriate communication route to be used for the P2P communication, from communication routes satisfying the required conditions (desired quality). For example, the control apparatus 10 selects the communication route having the best communication quality.

When there is no communication route satisfying the required conditions, the control apparatus 10 can determine the communication route for which the required conditions have the best items. Note that, in this case, the control apparatus 10 may notify the terminal devices 40 that there is no communication route satisfying the required conditions.

For example, the required conditions in the P2P communication include an average value/minimum value/median value/variance/standard deviation of the communication quality required in the P2P communication. Note that the communication quality includes the following items.
Throughput (bit rate and packet rate)
Frequency bandwidth (system bandwidth)
Delay amount (jitter and response time)
Reliability (bit error rate, packet error rate, and frame error rate)
Network congestion (degree of congestion)
Reception quality (SNR and SINR)

Examples of the reception quality include reference signal received power (RSRP), reference signal received quality (RSRQ), reference signal strength indicator (RSSI), and the like. Furthermore, examples of the reception quality include a signal-to-noise power ratio (SNR), a signal-to-interference-and-noise power ratio (SINR), and the like.

The required conditions can be requested by the terminal devices 40. Alternatively, the required conditions may be determined according to the type of data transmitted and received by the terminal devices 40. The required conditions may be minimum conditions required to be satisfied, or may be conditions required to be satisfied on average. Notice of the required conditions may be individually given, for each of downlink/uplink.

Although details will be described later, the quality information used by the control apparatus 10 to determine the communication route can include the date and time of acquisition or measurement. The control apparatus 10 can compare the date and time of acquisition or measurement of the quality information with the current date and time to assign a weight to the quality information. In other words, the control apparatus 10 is configured to determine the communication route in consideration of freshness (new and old) of the quality information. For example, the control apparatus 10 can use a forgetting factor or the like as the weight assigned to the quality information.

Here, as described above, depending on the wireless communication systems, communication is performed by using the shared spectrum, in some cases. In this way, in a case where a predetermined wireless communication system uses a frequency that is the shared spectrum, the control apparatus 10 determines the communication route on the basis of the priority (e.g., Tier 1/2/3 described above, etc.) of the predetermined wireless communication system.

The control apparatus 10 individually controls the wireless communication systems, in the sites L_A and L_B of the first and second terminal devices 40A and 40B, respectively.

The control apparatus 10 determines the communication route in consideration of the positions of the terminal devices 40 (countries, regions, and areas), the positions of the base stations 20, rules applied to the positions of the sites L (laws, systems, and rules), and the like.

The control apparatus 10 determines the communication route in consideration of the position, time, interference power, and the like upon use of the shared spectrum by a wireless communication system having a higher priority than the wireless communication systems to be controlled.

### (Transmission of Route Information)

In Steps S106 and S107 of the determination process described above, the control apparatus 10 transmits the route information to the first and second terminal devices 40A and 40B. The route information includes the communication parameters used by the first and second terminal devices 40A and 40B for the P2P communication.

The communication parameters include, for example, information (LTE, NR, WiFi 4/5/6, etc.) about the RATs to which the terminal devices 40 are to be connected.

When the RATs to be connected are a cellular network (e.g., LTE and NR), the following information can be included as the communication parameter.
Frequency information (e.g., frequency band, center frequency, system bandwidth, a subcarrier spacing, etc.)
Cell ID
APN
Information about synchronization signals/physical broadcast channel (SS/PBCH)

When the RATs to be connected are WLAN (e.g., WiFi 4/5/6), the following information can be included as the communication parameter.
Frequency information (e.g., frequency band (2.4 GHZ/5 GHZ/6 GHZ/60 GHZ), channel number, etc.)
Number of each access point
Password required for connection to each access point

In a case where the frequency used by the predetermined wireless communication system (e.g., RAT to be connected) is the shared spectrum, information about the frequency (shared spectrum) can be included as the communication parameter.

The information about the shared spectrum includes, for example, information about a frequency used for communication, available frequency, and unavailable frequency. Note that the frequency can include a frequency band, a center frequency, a frequency bandwidth, and the like.

Furthermore, the information about the shared spectrum can include the time for using the frequency, the time when the frequency is available, and the time when the frequency is unavailable. Note that the time includes a time length, a start time, an end time, and the like.

Furthermore, in a case where the frequency is controlled depending on the position in each site L, information about the position can be included in the information about the shared spectrum.

### (Timing for Execution of Determination Process)

The above-described communication route determination process can be executed at various timings and/or frequencies.

For example, the determination process is performed once, when the first terminal device 40A establishes the P2P connection with the second terminal device 40B, that is, at the start of the P2P connection.

Note that the determination process may be performed after the terminal devices 40 have established the P2P connection. In this case, the determination process is performed, for example, at predetermined periods.

In other words, the control apparatus 10 periodically updates the position information of each terminal device 40 and updates transmission parameters (communication parameters). Note that the control apparatus 10 may acquire the terminal information changed by the update, from the terminal device 40. Furthermore, the control apparatus 10 may transmit the route information (communication parameters) updated, to each terminal device 40.

Note that the predetermined period for performing the determination process may be determined by the control apparatus 10 or may be determined by each terminal device 40. Alternatively, the predetermined period may be defined in advance.

The determination process may be individually performed, for example, for each type of data transmitted from the terminal devices 40. Examples of the data type include data importance (priority), data sensitivity, and data payload size.

Furthermore, as described above, in a case where the frequency used by the predetermined wireless communication system is the shared spectrum, the determination process may be performed when the frequency used by the predetermined wireless communication system is changed.

Note that, when the determination process is started by the control apparatus 10, the control apparatus 10 can transmit a transmission request for transmission of the terminal information, to the first terminal device 40A, instead of Step S101 in FIG. 7. Furthermore, when the determination process is started by any of the terminal devices 40, the terminal device 40 may transmit a route change request (i.e., an execution request for the determination process) to the control apparatus 10, instead of the connection request in Step S101.

The method of determining (controlling) the communication route by the control apparatus 10 has been described above. Hereinafter, the acquisition method for acquiring the quality information by the control apparatus 10 will be described.

### 3.2. Acquisition Method for Quality Information

### (Method of Acquiring Quality Information by Measurement)

In an embodiment of the present disclosure, as described above, the communication quality is measured in order for the terminal devices 40 between the different sites L to be connected to each other by using the more appropriate communication route (communication link).

Here, the communication quality measured as the quality information is the same as the communication quality required for the P2P connection described above.

A specific measurement method for the communication quality includes an existing measurement method. For example, when measuring the throughput, Iperf can be used as a measurement tool. Alternatively, when measuring the response time, ping can be used as the measurement tool.

The communication quality is measured by at least one of a terminal device 40 and the control apparatus 10.

When the terminal device 40 measures the communication quality, the terminal device 40 generates the quality information about the basis of a result of the measurement and transmits the quality information to the control apparatus 10.

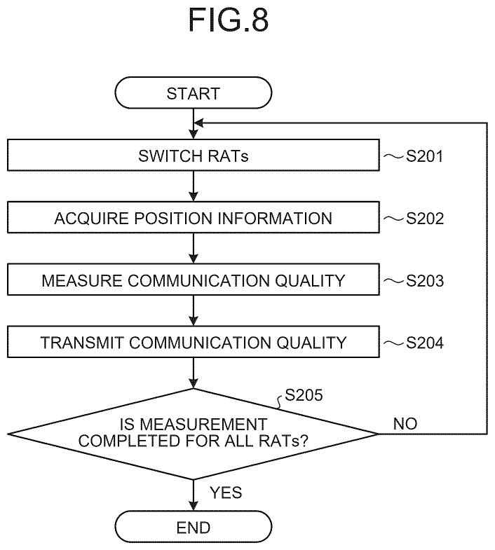

FIG. 8 is a flowchart illustrating an example of a communication quality measurement process according to an embodiment of the present disclosure. The measurement process illustrated in FIG. 8 is executed, for example, by each terminal device 40. The terminal device 40 performs the measurement process, for example, in accordance with an instruction from the control apparatus 10. Alternatively, the terminal device 40 may perform the measurement process, for example, at a predetermined timing (e.g., at predetermined periods). Furthermore, here, the terminal device 40 is connectable to a plurality of RATs (and/or base stations 20).

As illustrated in FIG. 8, the terminal device 40 switches the RATs (Step S201). when the communication quality is not measured in all the RATs, the terminal device 40 may select a predetermined RAT.

Next, the terminal device 40 acquires the position information of itself (Step S202). The terminal device 40 measures the communication quality (Step S203). The terminal device 40 transmits the measured communication quality as the quality information to the control apparatus 10 (Step S204). At this time, the terminal device 40 can transmit the position information of itself, information about the RAT to be measured, and the quality information associated with each other, to the control apparatus 10. The control apparatus 10 having received the quality information stores and holds the received quality information, associated with the terminal device 40, in a database or the like.

The terminal device 40 determines whether the measurement of the communication quality of all the RATs is completed (Step S205). When there is a RAT that is not measured (Step S205; No), the terminal device 40 returns to Step S201. On the other hand, when the measurement of the communication quality has been completed in all the RATS (Step S205; Yes), the terminal device 40 finishes the process.

The control apparatus 10 can directly control the terminal device 40, causing the terminal device 40 to perform the measurement process of FIG. 8. Alternatively, the terminal device 40 may perform the measurement process of FIG. 8 on the basis of control information transmitted from the control apparatus 10.

In addition, it is assumed that the frequency used by the predetermined wireless communication system is the shared frequency. In this configuration, the control apparatus 10 controls whether to measure the communication quality on the basis of whether the frequency is available. As described above, the control apparatus 10 controls the frequency and time, for each site L.

### (Target to be Measured for Communication Quality)

In an embodiment of the present disclosure, various targets to be measured for communication quality can be shown in the following. Furthermore, in the following description, unless otherwise specified, even in a case where it is described that the terminal device 40 measures the communication quality, the control apparatus 10 (and/or the base stations 20) can similarly measure the communication quality.

### [Option 1]

The terminal devices 40 each measure individual communication quality in each site L.

[Option 1-a]

Each terminal device 40 measures the communication quality in each wireless section (between the terminal device 40 and each base station 20).

The propagation path characteristic is different between communication links (RATs and/or base stations 20). Therefore, the communication quality in the wireless section differs between the communication links. Furthermore, even in a case where the terminal device 40 is fixed, the communication quality in the wireless section changes depending on the surrounding situation. Therefore, the terminal device 40 measures the communication quality in the wireless section for each communication link, regardless of whether the terminal device 40 is movable.

In this method, even when the communication quality changes due to the movement of the terminal device 40, the terminal device 40 is configured to measure the communication quality with higher accuracy according to the changing. Therefore, the control apparatus 10 is allowed to select a more appropriate communication link (communication route) according to the communication quality.

Furthermore, this method can be implemented by communication layers lower than the application layer of the terminal device 40 (e.g., MAC layer, RRC layer, etc.). Therefore, the terminal device 40 is allowed to measure the communication quality with low latency. Furthermore, the control apparatus 10 is allowed to achieve control (e.g., determination of the communication route) and the like based on a result of the measurement with low latency.

[Option 1-b]

Each terminal device 40 measures the communication qualities of the backhaul sections (communication sections other than the wireless sections) in each site L.

Note that in this case, each backhaul section may include a predetermined communication node (e.g., the control apparatus) in the network N outside the site L. For example, the backhaul section can include a portion between the base stations 20 and the core networks 30, a portion between the base stations 20 and the control apparatus 10, a portion between the core networks 30 and the control apparatus 10, and the like.

In this configuration, the communication quality in the backhaul section does not include the communication quality in the wireless section described above. Therefore, when the base stations 20 do not move, the communication quality in the backhaul section does not change depending on the position of the terminal device 40. Meanwhile, for example, the degree of congestion in each communication link is likely to cause a change in communication quality in the backhaul section.

Measuring the communication quality in the backhaul section makes it possible for the control apparatus 10 to select a communication link in consideration of the degree of congestion and the like in each communication link. In addition, it is not necessary to consider the movement of the terminal device 40 or the like, and therefore, the terminal device 40 can relatively readily measure the communication quality in the backhaul section as compared with the measurement of the communication quality in the wireless section.

[Option 1-c]

Each terminal device 40 measures the communication quality having a combination of Option 1-a and Option 1-b. For example, the terminal device 40 measures the communication quality for each communication link between the terminal device 40 and the control apparatus 10. In this configuration, the terminal device 40 measures the communication quality in a communication section including the wireless section and the backhaul section, for each communication link. Therefore, the control apparatus 10 is allowed to select a communication link in consideration of the propagation path characteristic of the wireless section depending on the position of the terminal device 40, the degree of congestion in the backhaul section, and the like.

### [Option 2]

The terminal devices 40 measure the communication quality across the sites L.

[Option 2-a]

Each terminal device 40 measures the communication quality in each backhaul section (communication section other than the wireless section) between the sites L. For example, the terminal device 40 measures the communication quality between the base stations 20A in the first site L_A and the base stations 20B in the second site L_B.

When there is a plurality of base stations 20 in each site L (see FIG. 1), the terminal device 40 measure the communication quality for each combination of the plurality of base stations 20. For example, in a case where three base stations 20 for the WLAN, private LTE/NR, and public LTE/NR are arranged in each site L, the number of combinations of the base stations 20 between the first and second sites L_A and L_B is 3×3=9. In this configuration, the terminal device 40 measures the communication quality for each of all combinations.

Note that the terminal device 40 may be set in advance so as not to measure the communication quality for a combination of specific base stations 20. For example, the terminal device 40 can be set so as not to measure the communication quality in the backhaul section between the base station 20 for the private LTE/NR arranged in one site L and the base station 20 for the public LTE/NR arranged in the other site L.

[Option 2-b]

The terminal device 40 measures the communication quality of E2E communication between the terminal devices 40 in different sites L.

For example, the first terminal device 40A measures the communication quality between the first terminal device 40A in the first site L_A and the second terminal device 40B in the second site L_B. In other words, the communication quality includes those in the radio sections in the respective sites L and that in the backhaul section between the sites L.

In this configuration, the first terminal device 40A measures the communication quality between the first and second terminal devices 40A and 40B. Therefore, the first terminal device 40A is allowed to measure the communication quality equivalent to that when the first and second terminal devices 40A and 40B actually establish P2P connection.

In Option 2-b, the communication quality measured is affected by the position of the other terminal device 40 in addition to the position of the terminal device 40 itself. Therefore, the terminal device 40 preferably transmits the position information of the other terminal device 40 added to the quality information, in addition to the position information of the terminal device 40 itself, to the control apparatus 10.

As described above, when there is the plurality of base stations 20 in each L, the terminal device 40 can measure the communication quality for the combinations of the plurality of base stations 20. At this time, in Option 2-b, the terminal device 40 measures the communication quality including the wireless section. Therefore, in the measurement of the communication quality, the base stations 20 to which the terminal devices 40 in the sites L are connected are also important.

In this case, for example, the second terminal device 40B in the second site L_B is connected to the base station 20A₁ for WLAN first. In this state, the first terminal device 40A in the first site L_A sequentially switches the plurality of base stations 20A to be connected to measure the communication quality.

Next, the second terminal device 40B in the second site L_B is connected to the base station 20A₂ for the private LTE/NR. In this state, the first terminal device 40A in the first site L_A sequentially switches the plurality of base stations 20A to be connected to measure the communication quality.

In this way, the first and second terminal devices 40A and 40B sequentially switch the base stations 20 to be connected to measure the communication quality, and therefore, the terminal devices 40 are each configured to measure the communication quality in various communication routes.

In this configuration, each terminal device 40 preferably transmits, to the control apparatus 10, information indicating a base station (RAT) to which the other terminal device is connected, added to the quality information, in addition to information indicating a base station (RAT) to which the terminal device 40 itself is connected.

Note that the terminal device 40 may be set in advance so as not to measure the communication quality for a combination of specific base stations 20. For example, the terminal device 40 can be set so as not to measure the communication quality in the backhaul section between the base station 20 for the private LTE/NR arranged in one site L and the base station 20 for the public LTE/NR arranged in the other site L.

### (Method of Acquiring Quality Information Based on Control Information)

As another example of the acquisition method for the communication quality, there is a method of acquiring the quality information about the basis of control information used in each wireless communication system. Here, the control information (hereinafter, also referred to as system control information) used in the wireless communication system includes scheduling information that is transmitted from each base station 20 to each terminal device 40 and that is necessary to control resources of the wireless section and the transmission parameters. Usually, such scheduling information is adaptively generated according to the position and situation of the terminal device 40, a propagation path situation, and the like. Therefore, the scheduling information from the base station 20 is useful as the quality information indicating the communication quality.

For example, the control apparatus 10 acquires the system control information together with the position information from each base station 20 and/or terminal device 40, and stores the information. Furthermore, the control apparatus 10 uses the stored system control information as the quality information to determine the communication route according to the position of the terminal device 40.

The control apparatus 10 acquires the system control information through, for example, an application programming interface (API) of the base station 20.

Alternatively, it is assumed that the terminal device 40 holds the scheduling information transmitted from the base station 20. The control apparatus 10 acquires the scheduling information as the quality information, together with the position information, from the terminal device 40.

Alternatively, the terminal device 40 holds the system control information to be transmitted to the base station 20, on the basis of an instruction from the base station 20. The control apparatus 10 acquires the system control information as the quality information together with the position information, from the terminal device 40.

### (System Control Information)

Note that the system control information according to an embodiment of the present disclosure includes at least one of the following information.
Transmission/reception parameter information used by the terminal device 40 for downlink/uplink transmission
Report information fed back (reported) to the base station 20 by the terminal device 40
Connection terminal information about the terminal device 40 connected to the base station 20
Backhaul information about the backhaul link of the base station 20

### (Transmission/Reception Parameter Information)

The above-described transmission/reception parameter information includes, for example, the following information.
Information about physical resource mapping
Information about modulation and coding scheme (MCS)
Information about downlink/uplink transmission power
Information about precoating beam

The information about physical resource mapping is, for example, information about a frequency resource, a time resource, and the like. The control apparatus 10 is configured to grasp the physical resources allocated to one terminal device 40 to understand the degree of congestion and the like in the wireless communication system of the terminal device 40.

As described above, the transmission/reception parameter information includes information about the modulation scheme and MCS. The MCS is determined in relation to received power. The received power changes depending on the position of the terminal device 40. Therefore, the control apparatus 10 is allowed to acquire the MCS together with the position information of the terminal device 40 to predict the expected throughput of the terminal device 40 with relatively high accuracy.

As described above, the transmission/reception parameter information includes the information about downlink/uplink transmission power. In a case where the transmission power of the terminal device 40 has a limited maximum value, the size of a frequency resource to be allocated is determined according to the distance between the terminal device 40 and the base station 20. Therefore, acquiring the uplink transmission power of the terminal device 40 makes it possible for the control apparatus 10 to predict the maximum value of the expected uplink throughput of the terminal device 40.

### (Report Information)

The above-described report information includes, for example, the following information.
Channel state information (CSI) feedback information
Information about HARQ-ACK (ACK or NACK)
Radio resource management (RRM) feedback information

Examples of the CSI feedback information include the following information.
Channel quality indicator (CQI)
Precoding matrix indicator (PMI)
CSI-RS resource indicator (CRI)
SS/PBCH block resource indicator (SSBRI)
Layer indicator (LI)
Rank indicator (RI)
L1-RSRP or L1-SINR

The CSI feedback information is generated in consideration of the position of the terminal device 40 and the propagation path situation, and is used to schedule the base station 20. Therefore, the control apparatus 10 is allowed to acquire the CSI feedback information together with the position information of the terminal device 40 to grasp the communication quality unique to the wireless communication system of the terminal device 40.

In particular, the CSI feedback information can follow shadowing in the propagation path situation compared with the RRM feedback information. Therefore, the control apparatus 10 is allowed to use the CSI feedback information as dynamic quality information. For example, the CSI feedback information can be used to update the communication route by the control apparatus 10.

Examples of the RRM feedback information include the following information.
SS reference signal received power (SS-RSRP)
CSI reference signal received power (CSI-RSRP)
SS reference signal received quality (SS-RSRQ)
CSI reference signal received quality (CSI-RSRQ)
SS signal-to-noise and interference ratio (SS-SINR)
CSI signal-to-noise and interference ratio (CSI-SINR)

The RRM feedback information is generated in consideration of the position of the terminal device 40 and the propagation path situation, and is used to schedule the base station 20. Therefore, the control apparatus 10 is allowed to acquire the RRM feedback information together with the position information of the terminal device 40 to grasp the communication quality unique to the wireless communication system of the terminal device 40.

In particular, the RRM feedback information can follow pathloss in the propagation path situation compared with the CSI feedback information. Therefore, the control apparatus 10 is allowed to use the RRM feedback information as semi-static quality information. For example, the RRM feedback information can be used to determine the communication route by the control apparatus 10 upon initial connection of the P2P connection.

### (Connection Terminal Information)

The above-described connection terminal information includes, for example, the number of RRC_Idle terminals, the number of RRC_connected terminals, the number of RRC_Inactive terminals, and the like. Acquisition of the connection terminal information makes it possible for the control apparatus 10 to grasp the degree of congestion and the like in the wireless communication system through which the base station 20 provides the service. Therefore, the control apparatus 10 is allowed to predict the expected maximum throughput and the like expected of the terminal device 40.

As described above, the control apparatus 10 according to the embodiment of the present disclosure acquires the quality information, and determines the communication route for P2P connection by using the acquired quality information.

The control apparatus 10 includes the control unit 130. The control unit 130 acquires the position of the first terminal device 40A and first quality information about the communication qualities of communication between the first terminal device 40A and the plurality of links, from the first terminal device 40A. The first terminal device 40A is positioned in the first site L_A in which a first base station 20A₂ connected to a first private network is arranged, and is connectable to a plurality of links including the first private network.

The control unit 130 acquires the position of the second terminal device 40B and second quality information about the communication qualities of communication with the plurality of links, from the second terminal device 40B. The second terminal device 40B is positioned in the second site L_B that is different from the first site L_A and in which a second base station 20B₂ connected to a second private network different from the first private network is arranged. The second terminal device 40B is connectable to the plurality of links including the second private network.

The control unit 130 acquires the first terminal information (an example of first communication information) about the first terminal device 40A, from the first terminal device 40A. The control unit 130 acquires the second terminal information (an example of second communication information) about the second terminal device 40B, from the second terminal device 40B.

The control unit 130 uses the first terminal information, the second terminal information, the first quality information, and the second quality information to determine the communication route that is a communication route between the first terminal device 40A and the second terminal device 40B and that satisfies a desired quality. The control unit 130 notifies the first terminal device 40A and the second terminal device 40B of the route information about the determined communication route.

Therefore, the control apparatus 10 is allowed to further improve the communication quality when the terminal devices 40 are connectable to a plurality of wireless communication systems in communication between the plurality of sites L.

### 4. MODIFICATIONS

### 4.1. First Modification

Even after the terminal devices 40 establishes the P2P connection once, the communication qualities can change due to movement of the terminal devices 40 or a change in surroundings. Therefore, it is preferable for the control apparatus 10 to update the quality information even during the P2P connection and adaptively control the communication route (communication link).

### (Update of Quality Information)

Here, a method of updating the quality information by the control apparatus 10 during the P2P connection (method of upload processing for the quality information) will be described. Examples of the method of updating the quality information during the P2P connection include the following methods.

The terminal devices 40 each sequentially switch the communication links to measure the communication qualities, and transmit the communication qualities to the control apparatus 10, regardless of a communication state (during data transmission, during data reception, etc.) of the terminal device. The upload processing for the quality information is performed periodically or aperiodically by an instruction from the control apparatus 10 or determination by each terminal device 40.

In another example of the upload processing, the terminal devices 40 each sequentially switches the communication links to measure the communication qualities during a time period in which data transmission and reception is not performed, in consideration of the communication state of the terminal device 40 itself, and transmits the communication qualities to the control apparatus 10. This upload processing can be executed, for example, on the basis of an instruction from the control apparatus 10 or determination by each terminal device 40.

In another example of the upload processing, the terminal devices 40 each sequentially switches the communication links in a predetermined time interval (sensing window) to measure the communication qualities, and transmits the communication qualities to the control apparatus 10.

The sensing window is, for example, a time set in advance at predetermined periods by the control apparatus 10. Each terminal device 40 is controlled not to transmit and receive data in the sensing window. In other words, the terminal device 40 transmits and receives the data in a time other than the sensing window.

Note that the sensing window may be defined as a time for switching the communication links. This configuration makes it possible for the terminal device 40 to switch communication and measure the communication qualities in the sensing window. Furthermore, the terminal device 40 can transmit and receive the data by using a communication link after switching.

### (Update of Communication Route)

The control apparatus 10 can periodically or aperiodically perform update to the more appropriate communication route according to the update of the quality information. During the P2P connection, the control apparatus 10 uses the updated quality information to reselect the communication route, updating the communication route. The control apparatus 10 periodically or aperiodically transmits the route information (transmission parameters) about the updated communication route to the terminal device 40.

### 4.2. Second Modification

In the embodiments described above, the communication system 1A includes one control apparatus 10, but the present disclosure is not limited thereto. For example, the communication system 1A may include a plurality of control apparatuses 10. For example, in the embodiments described above, one control apparatus 10 is arranged for the plurality of sites L, but the control apparatus 10 may be arranged in each of the plurality of sites L.

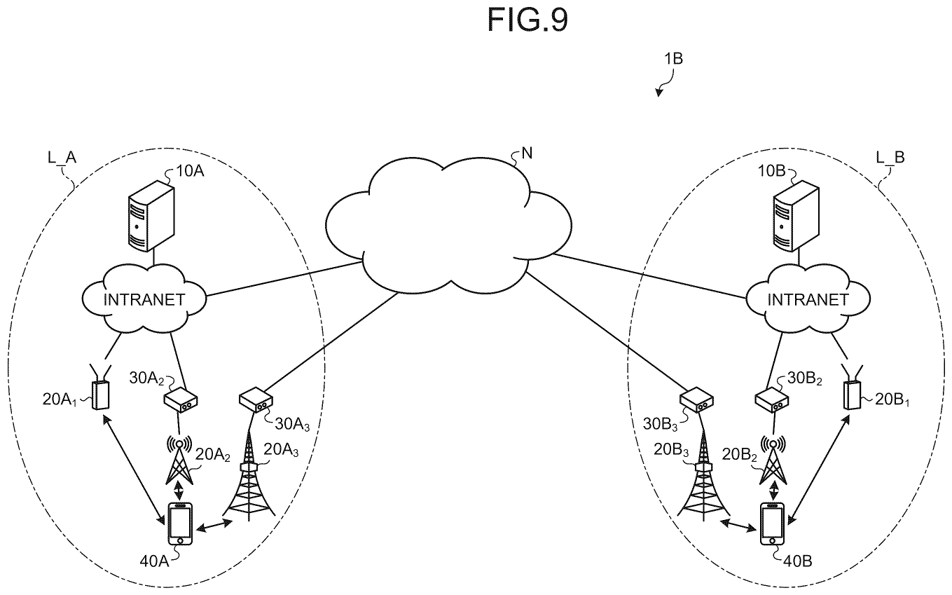

FIG. 9 is a diagram illustrating an exemplary configuration of a communication system 1B according to a second modification of the embodiment of the present disclosure.

A communication system 1B illustrated in FIG. 9 includes a first control apparatus 10A that is arranged in the first site L_A and a second control apparatus 10B that is arranged in the second site L_B, instead of the control apparatus 10 illustrated in FIG. 1.

The first control apparatus 10A is connected to the base stations 20A₁ and 20A₂ via an intranet in the first site L_A. In addition, the first control apparatus 10A is connected to the base station 20A₃ via the network N and the intranet.

The second control apparatus 10B is connected to the base stations 20B₁ and 20B₂ via the intranet in the second site L_B. In addition, the second control apparatus 10B is connected to the base station 20B₃ via the network N and the intranet.

The first and second control apparatuses 10A and 10B are connected to each other via the intranets and the network N.

Hereinafter, it is assumed that the first and second control apparatuses 10A and 10B in the first and second sites L_A and L_B hold the quality information in the respective sites L, but the present modification is not limited thereto. Some or all of the plurality of control apparatuses 10 may hold the quality information in the other site L.

In a case where the plurality of control apparatuses 10 is installed in the communication system 1B as in the present modification, a predetermined control apparatus 10 determines the communication route upon establishing P2P connection. At this time, when the predetermined control apparatus 10 holds no quality information necessary to determine the communication route, the predetermined control apparatus 10 can acquire the communication information from the other control apparatus holding the communication information.

The predetermined control apparatus 10 determining the communication route upon P2P connection can be determined by various methods. For example, the methods of determining the predetermined control apparatus 10 include the following examples.
A method of setting a control apparatus 10 in a site L in which there is a terminal device 40 requesting P2P connection, as the predetermined control apparatus 10
A method of setting a control apparatus 10 in a site L in which there is a terminal device 40 for which P2P connection is requested (i.e., the control apparatus 10 in the site L on the other side of a terminal device 40 requesting the P2P connection) as the predetermined control apparatus 10
A method of setting a control apparatus 10 having high priority set in advance for each control apparatus 10, as the predetermined control apparatus 10
A method of determining the predetermined control apparatus at random (e.g., the predetermined control apparatus 10 is determined using random numbers)
A method of determining the predetermined control apparatus 10 according to identification ID set in advance for each control apparatus 10 (e.g., a control apparatus 10 having a small or large identification ID is determined as the predetermined control apparatus 10)
A method of determining the predetermined control apparatus 10 by an integrated controller (not illustrated) controlling the control apparatuses 10

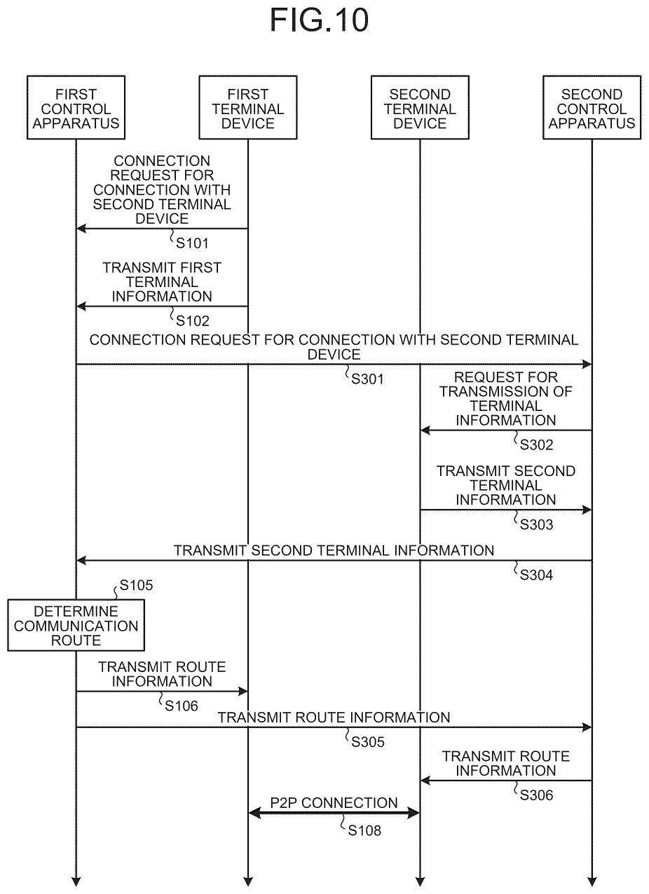

FIG. 10 is a sequence diagram illustrating an example of a communication route determination process according to the second modification of the embodiment of the present disclosure. Note that process steps the same as those in the determination process illustrated in FIG. 7 are denoted by the same reference numerals, and description thereof will be omitted as appropriate. In this case, the control apparatus 10 of FIG. 7 corresponds to the first control apparatus 10A of FIG. 10.

Here, it is assumed that the first terminal device 40A requests P2P connection with the second terminal device 40B, and the first control apparatus 10A operates as the predetermined control apparatus 10.

The first control apparatus 10A having acquired the first terminal information in Step S102 illustrated in FIG. 10 transmits the connection request for connection with the second terminal device 40B, to the second control apparatus 10B (Step S301).

The second control apparatus 10B having received the connection request transmits the transmission request for transmission of the terminal information, to the second terminal device 40B (Step S302). The second terminal device 40B transmits the second terminal information about the second terminal device 40B, to the second control apparatus 10B (Step S303). The second control apparatus 10B transmits the second terminal information to the first control apparatus 10A (Step S304).

The first control apparatus 10A transmits the route information about the determined communication route to the second control apparatus 10B (Step S305). The second control apparatus 10B transmits the received route information to the second terminal device 40B (Step S306).

In this way, in the present modification, each terminal device 40 in each site L is controlled by each control apparatus 10 in the same site L, and control across the sites L is performed between the control apparatuses 10. Note that for low latency in control, the first control apparatus 10A may directly transmit and receive control information to and from the second terminal device 40B. In this configuration, the first control apparatus 10A operates similarly to the control apparatus 10 illustrated in FIG. 7.

Note that the example of FIG. 10 illustrates the control apparatus 10 connected to the intranet to which the base station 20A₂ for the private LTE/NR and the base station 20A₁ for WLAN are connected, but the present modification is not limited thereto. For example, the control apparatus 10 may be connected to the public LTE/NR. In this configuration, the control apparatus 10 can be managed by a public LTE/NR network operator to which the control apparatus 10 is connected.

### 4.3. Third Modification

In the embodiment described above, two sites L have been described, but the number of sites L is not limited to two. Three or more sites L may be provided.

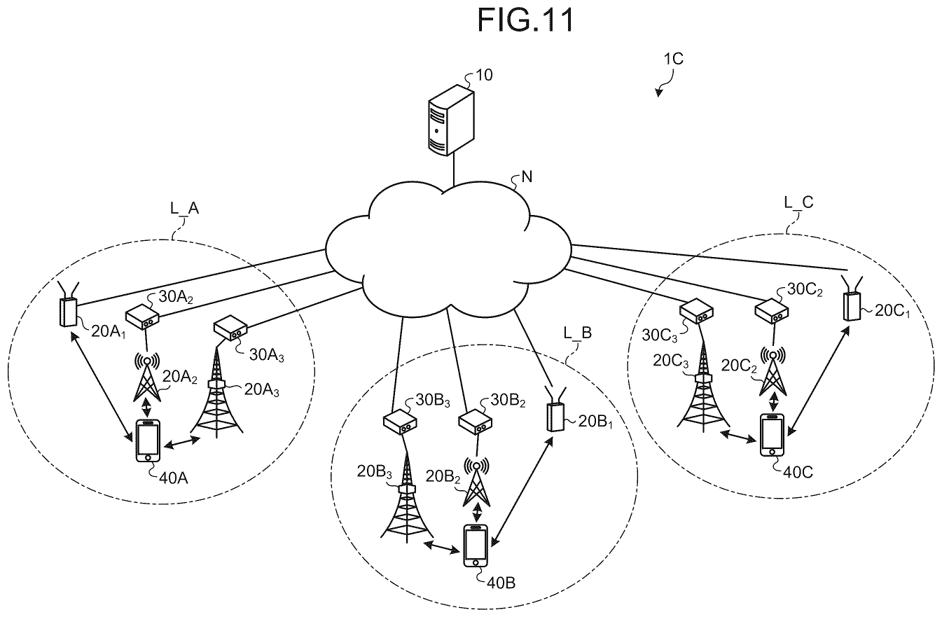

FIG. 11 is a diagram illustrating an exemplary configuration of a communication system 1C according to a third modification of the embodiment of the present disclosure.

The communication system 1C illustrated in FIG. 11 includes a third site L_C in addition to the first and second sites L_A and L_B illustrated in FIG. 1. In the third site L_C, a plurality of base stations 20C₁ to 20C₃ are arranged. The plurality of base stations 20C₁ to 20C₃ communicate with the plurality of base stations 20A₁ to 20A₃ and 20B₁ to 20B₃ via the network N.

In the example of FIG. 11, the base station 20C₁ is a wireless LAN access point. Furthermore, the base station 20C₂ is a base station for a private network (e.g., private LTE/NR), and is connected to the network N via a core network 30C₂ for the private network.

In addition, the base station 20C₃ is a base station for a public network (e.g., public LTE/NR), and is connected to the network N via a core network 30C₃ for the public network.

A third terminal device 40C is positioned in the third site L_C and is connected to one of the plurality of base stations 20C₁ to 20C₃ arranged in the third site L_C.

The first to third terminal devices 40A to 40C perform communication through P2P connection or P2M connection (or group connection). In this way, the first to third terminal devices 40A to 40C select one of a plurality of communication routes (communication links) and establish the P2P connection or P2M connection.

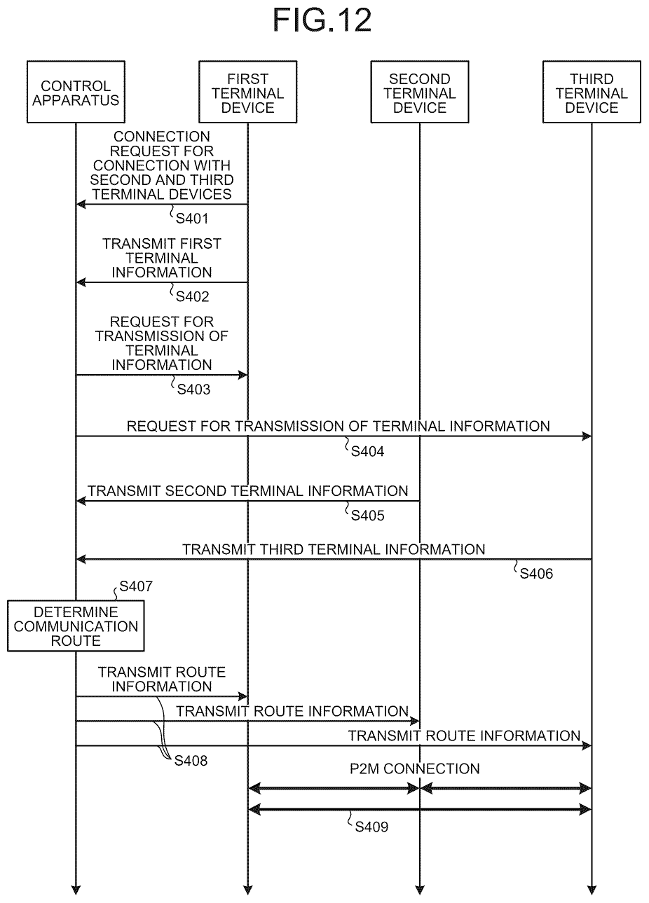

FIG. 12 is a sequence diagram illustrating an example of a communication route determination process according to the third modification of the embodiment of the present disclosure.

Here, it is assumed that the first terminal device 40A requests P2M connection with the second and third terminal devices 40B and 40C. In addition, it is assumed that the control apparatus 10 holds the quality information according to the positions of the first to third terminal devices 40A to 40C in advance.

As illustrated in FIG. 12, the first terminal device 40A transmits a connection request for connection with the second and third terminal devices 40B and 40C, to the control apparatus 10 (Step S401). The first terminal device 40A transmits the first terminal information to the control apparatus 10 (Step S402).

The control apparatus 10 having received the connection request transmits the transmission request for transmission of the terminal information, to the second terminal device 40B (Step S403), and transmits a transmission request for transmission of terminal information to the third terminal device 40C (Step S404).

The second terminal device 40B transmits the second terminal information to the control apparatus 10 (Step S405). The third terminal device 40C transmits third terminal information that is terminal information about the third terminal device 10C, to the control apparatus 10 (Step S406).

The control apparatus 10 determines a communication route used for the P2M connection between the first to third terminal devices 40A to 40C (Step S407). The control apparatus 10 transmits the route information about the determined communication route to each of the first to third terminal devices 40A to 40C (Step S408).

The first to third terminal devices 40A to 40C uses the received route information to establish the P2M connection with each other (Step S409), and perform P2M communication.

Note that the control apparatus 10 may individually determine more appropriate communication routes to be used for P2P connection between two of the first to third terminal devices 40A to 40C. In other words, the control apparatus 10 determines a communication route more suitable for the P2P connection between the first and second terminal devices 40A and 40B, as a first communication route. In addition, the control apparatus 10 determines a communication route more suitable for the P2P connection between the second and third terminal devices 40B and 40C, as a second communication route. In addition, the control apparatus 10 determines a communication route more suitable for the P2P connection between the first and third terminal devices 40A and 40C, as a third communication route.

In this configuration, the control apparatus 10 can transmit first to third route information about the first to third communication routes, to the first to third terminal devices 40A to 40C.

Note that in the present modification, determination of the more appropriate communication route by the control apparatus 10, for P2M connection between three or more terminal devices 40 positioned in different sites L has been described, but the present modification is not limited thereto. For example, also in P2M connection in a case where two or more terminal devices 40 are positioned in one site L, the control apparatus 10 is allowed to determine the more appropriate communication route as described in the present modification. For example, also in a case where the above-described third terminal device 40C is positioned in the second site L_B, the control apparatus 10 is allowed to determine the more appropriate communication route by executing the determination process illustrated in FIG. 12.

### 4.4. Fourth Modification

In the embodiment described above, one backhaul link is provided between the base stations 20 in the different sites L, but a plurality of (two or more) backhaul links may be provided between the base stations 20.

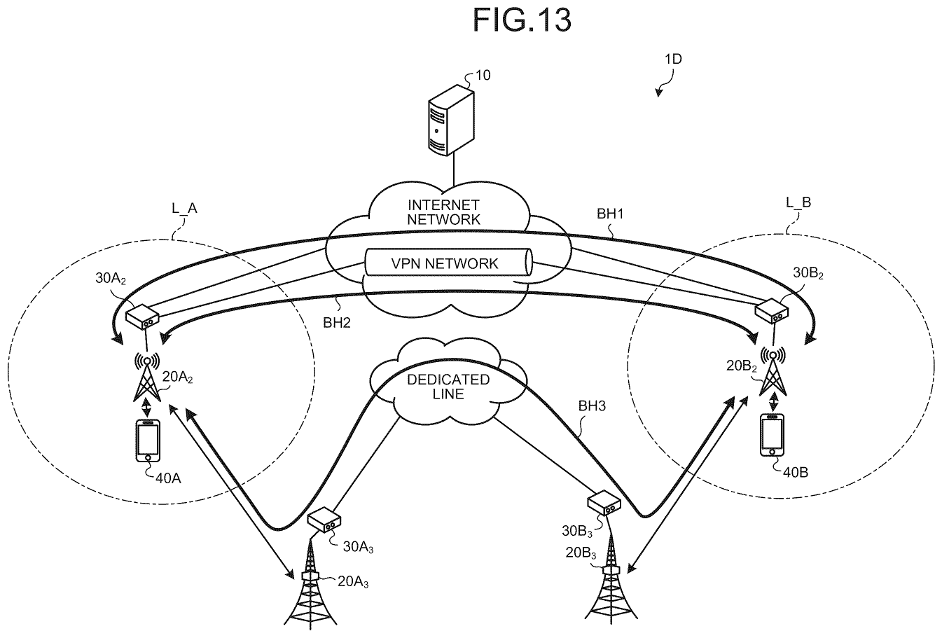

FIG. 13 is a diagram illustrating an exemplary configuration of a communication system 1D according to a fourth modification of the embodiment of the present disclosure. FIG. 13 illustrates the base station 20A₂ for the private LTE/NR arranged in the first site L_A without arrangement of the base station 20A₁ for wireless LAN. In addition, in FIG. 13, the base station 20A₃ for public LTE/NR is arranged around the first site L_A. Note that the second site L_B and the base stations 20B₁ to 20B₃ are also configured similarly to the first site L_A and the base stations 20A₁ to 20A₃.

In the communication system 1D illustrated in FIG. 13, the base station 20A₂ and the base station 20B₂ are connected through the internet network (first backhaul link BH1). In addition, the base station 20A₂ and the base station 20B₂ are connected through the VPN (second backhaul link BH2).

In addition, the base station 20A₂ and the base station 20B₂ are connected through the base station 20A₃, the base station 20B₃, and the dedicated link (third backhaul link BH3). In FIG. 13, the base stations 20A₂ and 20B₂ are connected to the base stations 20A₃ and 20B₃ through wireless communication, but may be connected through wired communication.

In this way, in the present modification, one set of the base stations 20 (base stations 20A₂ and 20B₂) can be connected by a plurality of backhaul links (first to third backhaul links BH1 to BH3).

The first terminal device 40A connected to the base station 20A₂ and the second terminal device 40B connected to the base station 20B₂ can make a selection from the three communication routes including the first to third backhaul links BH1 to BH3 upon P2P connection.

In this configuration, the control apparatus 10 determines a communication route most suitable for the P2P connection according to the communication quality of the first and second terminal devices 40A and 40B, from among the three communication routes including the first to third backhaul links BH1 to BH3. In other words, the control apparatus 10 makes a selection from a plurality of different backhaul links (first to third backhaul links BH1 to BH3) according to the situation of each terminal device 40, the type of data to be transmitted and received, and the like, in a controllable manner.

Note that in a case where a plurality of base stations 20A₂ and 20B₂ are arranged in each site L, the control apparatus 10 controllably selects a communication route individually, for each of the plurality of base stations 20A₂ and 20B₂ and the plurality of backhaul links to which the base stations 20A₂ and 20B₂ are connected.

### 4.5. Fifth Modification

Here, as a fifth modification of the embodiment of the present disclosure, another example of the route information (communication parameters) will be described.

As described above, the communication quality changes depending on the position of the terminal devices 40. For example, in a case where the terminal devices 40 are movable devices, the control apparatus 10 can transmit information (quality improvement information) for obtaining a more suitable communication quality as the route information, to the terminal devices 40.

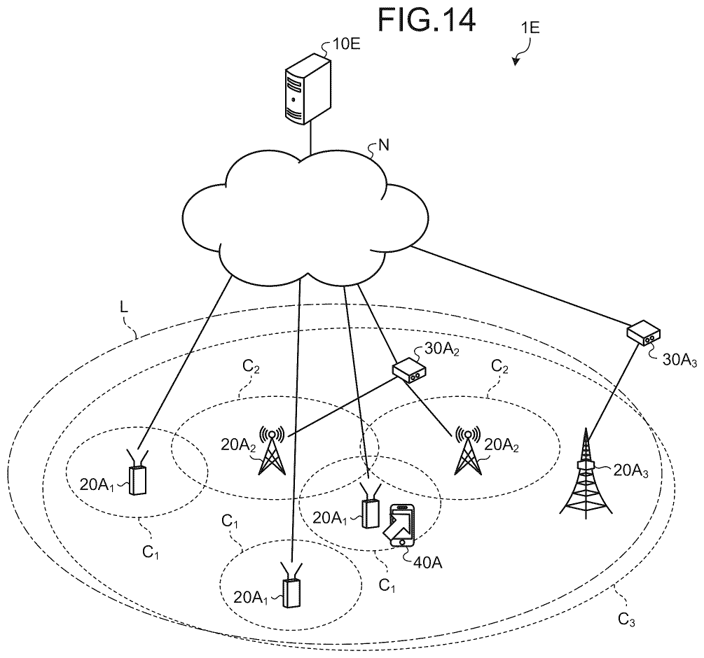

FIG. 14 is a diagram illustrating an example of a route information according to the fifth modification of the embodiment of the present disclosure. Here, it is assumed that the first terminal device 40A is a smartphone and the first terminal device 40A is used by a person (user). In addition, although the first site L_A is illustrated in FIG. 14, the second site L_B also has a similar configuration.

A control apparatus 10E of a communication system 1E according to the present modification transmits, for example, information for displaying a recommended moving direction, moving distance, and the like of the first terminal device 40A, to the first terminal device 40A, as information for obtaining the more suitable communication quality.

For example, in FIG. 14, it is assumed that the first terminal device 40A is allowed to perform communication with the more suitable communication quality when connected to the base station 20A₂ than connected to the base station 20A₁. In this configuration, the control apparatus 10E transmits, to the first terminal device 40A, information for displaying a moving direction, with a direction toward the base station 20A₂ as the recommended moving direction of the first terminal device 40A. For example, the control apparatus 10E transmits display information indicating the upper right of FIG. 14 as the moving direction, to the first terminal device 40A.

The first terminal device 40A presents the acquired display information to the user. At this time, the first terminal device 40A may present the display information superimposed on a map to the user.

Alternatively, the first terminal device 40A may present information indicating the communication quality, to the user. At this time, the first terminal device 40A may present the information indicating the communication quality, superimposed on a map, to the user.

Note that, it is assumed that the first terminal device 40A is the smartphone and the first terminal device 40A is used by the user, but the present modification is not limited thereto. For example, the first terminal device 40A may be mounted on a mobile robot. This configuration makes it possible for the control apparatus 10E to directly notify the first terminal device 40A of the moving direction and moving distance of the robot. For example, the robot moves in consideration of the moving direction and moving distance indicated by the notification.

Note that the information for obtaining the more suitable communication quality is not limited to the moving direction and/or the moving distance of the first terminal device 40A. For example, the information can be information about a moving route of the first terminal device 40A.

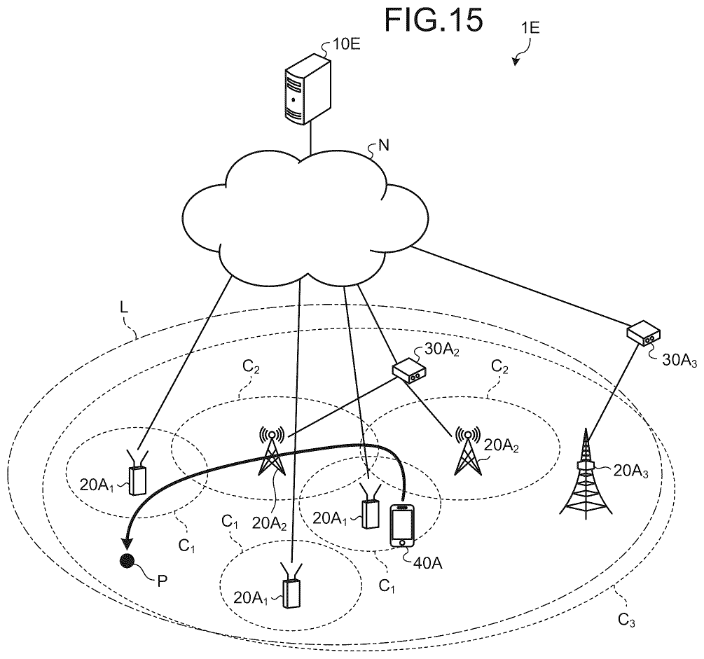

FIG. 15 is a diagram illustrating another example of the route information according to the fifth modification of the embodiment of the present disclosure. Here, it is assumed that the first terminal device 40A is a smartphone and the first terminal device 40A is used by a person (user). In addition, it is assumed that the user moves to a point P as a destination (hereinafter, also referred to as destination P).

In this configuration, the control apparatus 10E determines a moving route that is a route to the destination P and that has the more suitable communication quality. For example, in FIG. 15, the control apparatus 10E determines a moving route (see an arrow in FIG. 15) passing through the communication area C₂ of the base station 20A₂ and the communication area C₁ of the base station 20A₁, as the moving route having the more suitable communication quality.

The control apparatus 10E notifies the first terminal device 40A of information about the determined moving route, as the information for obtaining the more suitable communication quality.

As described above, the control apparatus 10E according to the present modification is configured to notify the first terminal device 40A of information for further improving the communication quality of the first terminal device 40A.

Note that the destination P in the present modification may not be the user's final destination. For example, the destination P of the present modification may include a transit point.

### 4.6. Sixth Modification

In the embodiments described above, the terminal devices 40 establish the P2P connection by using one communication route, but the present modification is not limited thereto. The terminal devices 40 may establish the P2P connection by using a plurality of communication routes.

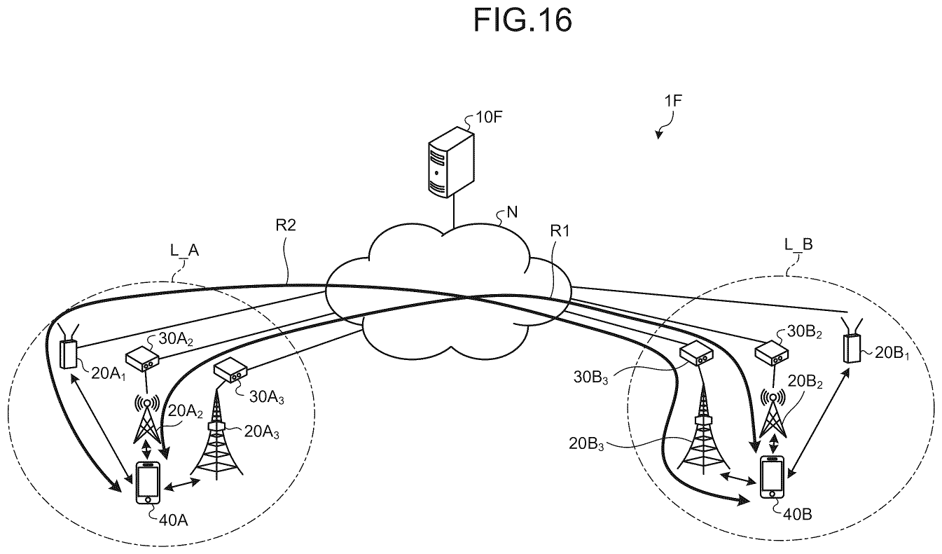

FIG. 16 is a diagram illustrating an example of the communication routes according to a sixth modification of the embodiment of the present disclosure. A control apparatus 10F of a communication system 1F illustrated in FIG. 16 selects a plurality of communication routes.

For example, in FIG. 16, the control apparatus 10F determines a first communication route R1 and a second communication route R2. The control apparatus 10F notifies the first and second terminal devices 40A and 40B of route information about the determined first and second communication routes R1 and R2.

The terminal devices 40 use for example, each of the first communication route R1 and the second communication route R2 to perform data duplication.

The terminal devices 40 exchange the same data by using, for example, each of the first communication route R1 and the second communication route R2. In this configuration, even if the communication quality of one of the communication routes deteriorates, there is a possibility that data communication can be performed by using the other communication route. In this way, the multiplexed (redundant) communication route makes it possible to provide E2E connection having higher reliability.

Note that the control apparatus 10F selects a communication route in a similar manner to the control apparatuses 10 of the embodiments and modifications described above, except for selecting the plurality of communication routes. Note that the following selection methods are also applicable as the communication route selection method in the embodiments and the modifications described above.

### (Selection of Plurality of Communication Routes)

In the present modification, the control apparatus 10F selects a plurality of communication routes by using at least some of the following selection methods.
A method of selecting a plurality of communication routes from among communication routes that satisfy predetermined required conditions, on the basis of the quality information measured in advance.
A method of selecting a plurality of communication routes on the basis of a correlation with a change in communication quality. For example, in this method, a plurality of communication routes each having a low correlation value with respect to the change in communication quality is selected.
A method of selecting a communication route using different wireless communication systems when a plurality of wireless communication systems is available in the sites L.
A method of selecting a communication route set or defined in advance, as some of a plurality of communication routes. For example, in this method, a communication route using private LTE/NR is selected as one of the plurality of communication routes.

### (Data Transmitted by Plurality of Communication Routes)

As described above, in the plurality of communication routes, the same duplicated data may be transmitted. Alternatively, the terminal devices 40 may each divide encoded data obtained by encoding data and transmit the divided encoded data through each of the communication routes.

For example, each terminal device 40 can use, as a data encoding method, network encoding, encoding using an exclusive OR, encoding using a fountain code, encoding using a Raptor code, or the like.

For example, the terminal device 40 selects a plurality of different encoding methods from the various encoding methods described above. The terminal devices 40 encode one piece of data by using different encoding methods, and generate a plurality of pieces of encoded data having different encoding methods. The terminal devices 40 transmit the plurality of pieces of encoded data through different communication routes.

Therefore, the terminal devices 40 can achieve communication having higher reliability than that when the terminal devices 40 simply transmit the same duplicated data.

Alternatively, the terminal devices 40 may transmit completely different data through each communication route. In this configuration, the terminal devices 40 individually transmit different data through the plurality of communication routes.

Therefore, the terminal devices 40 can achieve communication having larger capacity and higher speed, than that when the terminal devices 40 use one communication route.

### 5. OTHER EMBODIMENTS

The embodiments described above are merely examples, and various modifications and applications are possible.

For example, control devices that control the control apparatus 10, the base station 20, and the terminal device 40 according to the present embodiment may be implemented by a dedicated computer system or a general-purpose computer system.

For example, communication programs for performing the operations described above are stored in a computer-readable recording medium such as an optical disk, semiconductor memory, magnetic tape, or flexible disk, for distribution. Then, for example, the programs are installed on the computer to perform the processes described above, and thereby the control devices are configured. In this configuration, the control devices may be devices (e.g., a personal computer) outside the control apparatus 10, the base station apparatus 20, and the terminal device 40. Furthermore, the control devices may be devices (e.g., the control unit 130, control unit 23, and control unit 43) inside the control apparatus 10, base station 20, and terminal device 40.

Furthermore, each of the communication programs may be stored in a disk device included in a server device on a network such as the Internet, for example, so as to be downloaded to the computer. Furthermore, the functions described above may be implemented by cooperation between the operating system (OS) and application software. In this configuration, a portion other than the OS may be stored in a medium for distribution, or the portion other than the OS may be stored in the server device, for example, for downloading or the like to the computer.

Furthermore, of the processes described in the above embodiments, all or some of the processes described to be performed automatically may be performed manually, or all or some of processes described to be performed manually may be performed automatically by a known method. In addition, the processing procedures, specific names, and information including various data and parameters, which are described in the above description or illustrated in the drawings, can be appropriately changed unless otherwise specified. For example, various information illustrated in the drawings are not limited to the illustrated information.

Furthermore, the component elements of the devices are illustrated as functional concepts but are not necessarily required to be physically configured as illustrated. In other words, specific forms of distribution or integration of the devices are not limited to those illustrated, and all or some of the devices may be configured by being functionally or physically distributed or integrated in appropriate units, according to various loads or usage conditions. Note that the configuration obtained by the distribution or integration may be formed dynamically.

Furthermore, the embodiments described above can be appropriately combined within a range consistent with the contents of the processing. Furthermore, the order of the steps illustrated in each of the flowchart and sequence diagrams of the embodiments described above can be changed appropriately.

Furthermore, for example, the present embodiment can be implemented as all configurations constituting an apparatus or system, such as a processor as a system large scale integration (LSI) or the like, a module using a plurality of the processors or the like, a unit using a plurality of the modules or the like, and a set (i.e., a configuration of part of the apparatus) obtained by further adding the other functions to the unit.

Note that, in the present embodiment, the system means an aggregation of a plurality of component elements (devices, modules (components), etc.), and it does not matter whether all the component elements are in the same housing. Therefore, the plurality of devices that is housed in separate housings and connected via a network, and one device including the plurality of modules housed in one housing are both systems.

Furthermore, for example, the present embodiment can adopt a configuration of cloud computing in which one function is shared between the plurality of devices via a network to perform processing by the plurality of devices in cooperation.

### 6. CONCLUSION

Although the embodiments of the present disclosure have been described above, the technical scope of the present disclosure is not limited to the embodiments described above and various modifications can be made without departing from the spirit and scope of the present disclosure. Moreover, the component elements of different embodiments and modifications may be suitably combined with each other.

Furthermore, the effects in the embodiments described herein are merely examples, the present invention is not limited to these effects, and other effects may also be provided.

Note that the present technology can also have the following configurations.

(1)

A control apparatus comprising:
a control unit that
acquires a position of a first communication device and first quality information about communication quality with a plurality of links, from the first communication device being positioned in a first site having a first base station arranged therein to be connected to a first private network, the first communication device being connectable to the plurality of links including the first private network;
acquires a position of a second communication device and second quality information about communication quality with the plurality of links, from the second communication device being positioned in a second site having a second base station arranged therein to be connected to a second private network, the second private network being different from the first private network, the second site being different from the first site, the second communication device being connectable to the plurality of links including the second private network;
acquires first communication information about the first communication device, from the first communication device;
acquires second communication information about the second communication device, from the second communication device;
uses the first communication information, the second communication information, the first quality information, and the second quality information to determine a communication route between the first communication device and the second communication device, the communication route satisfying a desired quality; and
notifies the first communication device and the second communication device of route information about the determined communication route.

(2)

The control apparatus according to (1), wherein the first base station and the second base station are connected to different core networks.

(3)

The control apparatus according to (1) or (2), wherein the first base station and the second base station have different access point names.

(4)

The control apparatus according to (3), in which
the first base station has an access point name corresponding to the first site, and
the second base station has an access point name corresponding to the second site.

(5)

The control apparatus according to any one of (1) to (4), wherein
the control unit
acquires control information about the first communication device from the first base station;
acquires the control information about the second communication device from the second base station; and
determines the communication route by using the control information.

(6)

The control apparatus according to (5), wherein the control information includes at least one of position information about a position, resource information about an allocated resource, modulation information about a modulation method, encoding information about a code rate, power information about transmission power, beam information about a beam, and feedback information from each communication device.

(7)

The control apparatus according to any one of (1) to (6), wherein the control unit determines the communication route including at least one of the first private network, the second private network, and a network different from the first private network and the second private network.

(8)

The control apparatus according to any one of (1) to (7), wherein
the first site is a site corresponding to a communication area of the first base station, and
the second site is a site corresponding to a communication area of the second base station.

(9)

The control apparatus according to any one of (1) to (8), wherein the first communication information includes at least one of information about the first site and information about the plurality of links to which the first communication device is connectable.

(10)

The control apparatus according to any one of (1) to (9), wherein the control unit determines the communication route based on the desired quality required for communication between the first communication device and the second communication device.

(11)

The control apparatus according to any one of (1) to (10), wherein the desired quality includes any one of throughput, frequency bandwidth, delay amount, reliability, degree of congestion in a communication route, and reception quality.

(12)

The control apparatus according to any one of (1) to (11), wherein the control unit determines the communication route according to first time information about a date and time when the first quality information is acquired or measured, and second time information about a date and time when the second quality information is acquired or measured.

(13)

The control apparatus according to (12), in which the control unit compares the first time information with the current date and time to assign a weight to the first quality information, and compares the second time information with the current date and time to assign a weight to the second quality information.

(14)

The control apparatus according to any one of (1) to (13), wherein
the control unit
receives at least one of reliability information indicating reliability of the position information and acquisition information indicating an acquisition method for the position information, from at least one of the first communication device and the second communication device; and
uses at least one of the reliability information received and the acquisition information received to determine the communication route.

(15)

The control apparatus according to any one of (1) to (14), wherein when at least one of the first communication device and the second communication device uses a shared spectrum for at least one of the plurality of links, the control unit determines the communication route based on priority in use of the shared spectrum.

(16)

The control apparatus according to (15), wherein the control unit determines the communication route, according to at least one of a time, area, and interference power upon use of the shared spectrum by the wireless communication system having a higher priority in use of the shared spectrum, than the wireless communication system for the link using the shared spectrum, of the plurality of links.

(17)

The control apparatus according to (15) or (16), wherein the control unit gives notice of information about the shared spectrum, as the route information.

(18)

The control apparatus according to any one of (15) to (17), wherein the control unit determines the communication route again, when the shared spectrum used for communication between the first communication device and the second communication device is changed.

(19)

The control apparatus according to any one of (1) to (18), wherein the control unit gives notice of information about the link included in the communication route of the plurality of links, as information about the communication route determined.

(20)

The control apparatus according to any one of (1) to (19), wherein
the first communication device generates the first quality information based on information obtained by sequentially switching and measuring the plurality of links at predetermined time intervals, and notifies the control apparatus of the first quality information, and
the second communication device generates the second quality information based on information obtained by sequentially switching and measuring the plurality of links at predetermined time intervals, and notifies the control apparatus of the second quality information.

(21)

The control apparatus according to any one of (1) to (20), wherein
the control unit
acquires at least one of the second quality information and the second communication information via another control apparatus controlling the second base station included in the second site; and
notifies the second communication device of the route information via the another control apparatus.

(22)

The control apparatus according to any one of (1) to (21), wherein
the control unit
acquires a position of a third communication device and third quality information about communication quality with the plurality of links, from the third communication device being positioned in a third site having a third base station arranged therein to be connected to a third private network, the third private network being different from the first private network and the second private network, the third site being different from the first site and the second site, the third communication device being connectable to the plurality of links including the third private network;
acquires third communication information about the third communication device, from the third communication device;
uses the third communication information and the third quality information to determine the communication route between the third communication device and the first communication device and/or the second communication device, the communication route satisfying the desired quality; and
notifies the third communication device and the first communication device and/or the second communication device of the route information.

(23)

The control apparatus according to any one of (1) to (22), wherein
the control unit
notifies the first communication device and/or the second communication device of quality improvement information about at least one of a moving direction and a moving distance that provide improvement of the quality of communication between the first communication device and the second communication device.

(24)

The control apparatus according to (23), wherein the first communication device and/or the second communication device presents at least one of the moving direction and the moving distance that provide improvement of the quality of the communication, to a user, based on the quality improvement information.

(25)

The control apparatus according to any one of (1) to (24), in which the control unit determines a moving route of the first communication device and/or the second communication device according to a destination of the first communication device and/or the second communication device.

(26)

The control apparatus according to any one of (1) to (25), wherein
the control unit determines a plurality of the communication routes, and
the first communication device and the second communication device perform communication by using the plurality of the communication routes.

(27)

The control apparatus according to (26), in which the control unit determines a plurality of the communication routes based on a correlation with a change in communication quality of the communication route.

(28)

The control apparatus according to (26) or (27), wherein the first communication device and/or the second communication device divides encoded data obtained by encoding transmission data into a plurality of pieces of data, and transmits the divided encoded data through the plurality of the communication routes that are different from each other.

(29)

A communication device that is positioned in a first site having a first base station arranged therein to be connected to a first private network and is connectable to a plurality of links including the first private network, the communication device comprising:
a control unit that
transmits, to a control apparatus, a position of the communication device and first quality information about communication quality with the plurality of links;
transmits, to the control apparatus, a connection request for connection with a second communication device being positioned in a second site having a second base station arranged therein to be connected to a second private network, the second private network being different from the first private network, the second site being different from the first site, the second communication device being connectable to the plurality of links including the second private network;
transmits first communication information about the communication device, to the control apparatus; and
communicates with the second communication device, based on route information about a communication route with the second communication device, received from the control apparatus, wherein
the control apparatus acquires, from the second communication device, a position of the second communication device and second quality information about communication quality with the plurality of links;
acquires second communication information about the second communication device, from the second communication device;
uses the first communication information, the second communication information, the first quality information, and the second quality information to determine the communication route between the communication device and the second communication device, the communication route satisfying a desired quality; and
notifies the communication device and the second communication device of route information about the determined communication route.

(30)

A control method comprising:
acquiring a position of a first communication device and first quality information about communication quality with a plurality of links, from the first communication device being positioned in a first site having a first base station arranged therein to be connected to a first private network, the first communication device being connectable to the plurality of links including the first private network;
acquiring a position of a second communication device and second quality information about communication quality with the plurality of links, from the second communication device being positioned in a second site having a second base station arranged therein to be connected to a second private network, the second private network being different from the first private network, the second site being different from the first site, the second communication device being connectable to the plurality of links including the second private network;
acquiring first communication information about the first communication device, from the first communication device;
acquiring second communication information about the second communication device, from the second communication device;
using the first communication information, the second communication information, the first quality information, and the second quality information to determine a communication route between the first communication device and the second communication device, the communication route satisfying a desired quality; and
notifying the first communication device and the second communication device of route information about the determined communication route.

(31)

A communication method for a communication device being positioned in a first site having a first base station arranged therein to be connected to a first private network and being connectable to a plurality of links including the first private network, the communication method comprising:
transmitting, to a control apparatus, a position of the communication device and first quality information about communication quality with the plurality of links;
transmitting, to the control apparatus, a connection request for connection with a second communication device being positioned in a second site having a second base station arranged therein to be connected to a second private network, the second private network being different from the first private network, the second site being different from the first site, the second communication device being connectable to the plurality of links including the second private network;
transmitting first communication information about the communication device, to the control apparatus; and
communicating with the second communication device, based on route information about a communication route with the second communication device, received from the control apparatus, wherein
the control apparatus acquires, from the second communication device, a position of the second communication device and second quality information about communication quality with the plurality of links;
acquires second communication information about the second communication device, from the second communication device;
uses the first communication information, the second communication information, the first quality information, and the second quality information to determine the communication route between the communication device and the second communication device, the communication route satisfying a desired quality; and
notifies the communication device and the second communication device of route information about the determined communication route.

(32)

A communication system comprising:
a first communication device that is positioned in a first site having a first base station arranged therein to be connected to a first private network and that is connectable to a plurality of links including the first private network;
a second communication device that is positioned in a second site having a second base station arranged therein to be connected to a second private network, the second private network being different from the first private network, the second site being different from the first site, the second communication device being connectable to the plurality of links including the second private network; and
a control apparatus that controls a communication route between the first communication device and the second communication device, wherein
the first communication device transmits a position of the first communication device and first quality information about communication quality with the plurality of links, to the control apparatus,
the second communication device transmits a position of the second communication device and second quality information about communication quality with the plurality of links, to the control apparatus,
the first communication device transmits first communication information about the first communication device to the control apparatus,
the second communication device transmits second communication information about the second communication device to the control apparatus,
the control apparatus uses the first communication information, the second communication information, the first quality information, and the second quality information to determine the communication route between the first communication device and the second communication device, the communication route satisfying a desired quality; and
notifies the first communication device and the second communication device of route information about the determined communication route, and
the first communication device and the second communication device perform communication based on the route information.

### REFERENCE SIGNS LIST

1 COMMUNICATION SYSTEM
10 CONTROL APPARATUS
20 BASE STATION
21, 41 WIRELESS COMMUNICATION UNIT
22, 42, 120 STORAGE UNIT
23, 43, 130, 230 CONTROL UNIT
40 TERMINAL DEVICE
110, 210 COMMUNICATION UNIT
211, 411 TRANSMISSION PROCESSING UNIT
212, 412 RECEPTION PROCESSING UNIT
213, 413 ANTENNA

1. A control apparatus comprising:
a control unit that
acquires a position of a first communication device and first quality information about communication quality with a plurality of links, from the first communication device being positioned in a first site having a first base station arranged therein to be connected to a first private network, the first communication device being connectable to the plurality of links including the first private network;
acquires a position of a second communication device and second quality information about communication quality with the plurality of links, from the second communication device being positioned in a second site having a second base station arranged therein to be connected to a second private network, the second private network being different from the first private network, the second site being different from the first site, the second communication device being connectable to the plurality of links including the second private network;
acquires first communication information about the first communication device, from the first communication device;
acquires second communication information about the second communication device, from the second communication device;
uses the first communication information, the second communication information, the first quality information, and the second quality information to determine a communication route between the first communication device and the second communication device, the communication route satisfying a desired quality; and
notifies the first communication device and the second communication device of route information about the determined communication route.

2. The control apparatus according to claim 1, wherein the first base station and the second base station are connected to different core networks.

3. The control apparatus according to claim 1, wherein the first base station and the second base station have different access point names.

4. The control apparatus according to claim 1, wherein
the control unit
acquires control information about the first communication device from the first base station;
acquires the control information about the second communication device from the second base station; and
determines the communication route by using the control information.

5. The control apparatus according to claim 4, wherein the control information includes at least one of position information about a position, resource information about an allocated resource, modulation information about a modulation method, encoding information about a code rate, power information about transmission power, beam information about a beam, and feedback information from each communication device.

6. The control apparatus according to claim 1, wherein the control unit determines the communication route including at least one of the first private network, the second private network, and a network different from the first private network and the second private network.

7. The control apparatus according to claim 1, wherein
the first site is a site corresponding to a communication area of the first base station, and
the second site is a site corresponding to a communication area of the second base station.

8. The control apparatus according to claim 1, wherein the first communication information includes at least one of information about the first site and information about the plurality of links to which the first communication device is connectable.

9. The control apparatus according to claim 1, wherein the control unit determines the communication route based on the desired quality required for communication between the first communication device and the second communication device.

10. The control apparatus according to claim 1, wherein the desired quality includes any one of throughput, frequency bandwidth, delay amount, reliability, degree of congestion in a communication route, and reception quality.

11. The control apparatus according to claim 1, wherein the control unit determines the communication route according to first time information about a date and time when the first quality information is acquired or measured, and second time information about a date and time when the second quality information is acquired or measured.

12. The control apparatus according to claim 1, wherein
the control unit
receives at least one of reliability information indicating reliability of the position information and acquisition information indicating an acquisition method for the position information, from at least one of the first communication device and the second communication device; and
uses at least one of the reliability information received and the acquisition information received to determine the communication route.

13. The control apparatus according to claim 1, wherein when at least one of the first communication device and the second communication device uses a shared spectrum for at least one of the plurality of links, the control unit determines the communication route based on priority in use of the shared spectrum.

14. The control apparatus according to claim 13, wherein the control unit determines the communication route, according to at least one of a time, area, and interference power upon use of the shared spectrum by the wireless communication system having a higher priority in use of the shared spectrum, than the wireless communication system for the link using the shared spectrum, of the plurality of links.

15. The control apparatus according to claim 13, wherein the control unit gives notice of information about the shared spectrum, as the route information.

16. The control apparatus according to claim 13, wherein the control unit determines the communication route again, when the shared spectrum used for communication between the first communication device and the second communication device is changed.

17. The control apparatus according to claim 1, wherein the control unit gives notice of information about the link included in the communication route of the plurality of links, as information about the communication route determined.

18. The control apparatus according to claim 1, wherein
the first communication device generates the first quality information based on information obtained by sequentially switching and measuring the plurality of links at predetermined time intervals, and notifies the control apparatus of the first quality information, and
the second communication device generates the second quality information based on information obtained by sequentially switching and measuring the plurality of links at predetermined time intervals, and notifies the control apparatus of the second quality information.

19. The control apparatus according to claim 1, wherein
the control unit
acquires at least one of the second quality information and the second communication information via another control apparatus controlling the second base station included in the second site; and
notifies the second communication device of the route information via the another control apparatus.

20. The control apparatus according to claim 1, wherein
the control unit
acquires a position of a third communication device and third quality information about communication quality with the plurality of links, from the third communication device being positioned in a third site having a third base station arranged therein to be connected to a third private network, the third private network being different from the first private network and the second private network, the third site being different from the first site and the second site, the third communication device being connectable to the plurality of links including the third private network;
acquires third communication information about the third communication device, from the third communication device;
uses the third communication information and the third quality information to determine the communication route between the third communication device and the first communication device and/or the second communication device, the communication route satisfying the desired quality; and
notifies the third communication device and the first communication device and/or the second communication device of the route information.

21. The control apparatus according to claim 1, wherein
the control unit
notifies the first communication device and/or the second communication device of quality improvement information about at least one of a moving direction and a moving distance that provide improvement of the quality of communication between the first communication device and the second communication device.

22. The control apparatus according to claim 21, wherein the first communication device and/or the second communication device presents at least one of the moving direction and the moving distance that provide improvement of the quality of the communication, to a user, based on the quality improvement information.

23. The control apparatus according to claim 1, wherein
the control unit determines a plurality of the communication routes, and
the first communication device and the second communication device perform communication by using the plurality of the communication routes.

24. The control apparatus according to claim 23, wherein the first communication device and/or the second communication device divides encoded data obtained by encoding transmission data into a plurality of pieces of data, and transmits the divided encoded data through the plurality of the communication routes that are different from each other.

25. A communication device that is positioned in a first site having a first base station arranged therein to be connected to a first private network and is connectable to a plurality of links including the first private network, the communication device comprising:
a control unit that
transmits, to a control apparatus, a position of the communication device and first quality information about communication quality with the plurality of links;
transmits, to the control apparatus, a connection request for connection with a second communication device being positioned in a second site having a second base station arranged therein to be connected to a second private network, the second private network being different from the first private network, the second site being different from the first site, the second communication device being connectable to the plurality of links including the second private network;
transmits first communication information about the communication device, to the control apparatus; and
communicates with the second communication device, based on route information about a communication route with the second communication device, received from the control apparatus, wherein
the control apparatus acquires, from the second communication device, a position of the second communication device and second quality information about communication quality with the plurality of links;
acquires second communication information about the second communication device, from the second communication device;
uses the first communication information, the second communication information, the first quality information, and the second quality information to determine the communication route between the communication device and the second communication device, the communication route satisfying a desired quality; and
notifies the communication device and the second communication device of route information about the determined communication route.

26. A control method comprising:
acquiring a position of a first communication device and first quality information about communication quality with a plurality of links, from the first communication device being positioned in a first site having a first base station arranged therein to be connected to a first private network, the first communication device being connectable to the plurality of links including the first private network;
acquiring a position of a second communication device and second quality information about communication quality with the plurality of links, from the second communication device being positioned in a second site having a second base station arranged therein to be connected to a second private network, the second private network being different from the first private network, the second site being different from the first site, the second communication device being connectable to the plurality of links including the second private network;
acquiring first communication information about the first communication device, from the first communication device;
acquiring second communication information about the second communication device, from the second communication device;
using the first communication information, the second communication information, the first quality information, and the second quality information to determine a communication route between the first communication device and the second communication device, the communication route satisfying a desired quality; and
notifying the first communication device and the second communication device of route information about the determined communication route.

27. A communication method for a communication device being positioned in a first site having a first base station arranged therein to be connected to a first private network and being connectable to a plurality of links including the first private network, the communication method comprising:
transmitting, to a control apparatus, a position of the communication device and first quality information about communication quality with the plurality of links;
transmitting, to the control apparatus, a connection request for connection with a second communication device being positioned in a second site having a second base station arranged therein to be connected to a second private network, the second private network being different from the first private network, the second site being different from the first site, the second communication device being connectable to the plurality of links including the second private network;
transmitting first communication information about the communication device, to the control apparatus; and
communicating with the second communication device, based on route information about a communication route with the second communication device, received from the control apparatus, wherein
the control apparatus acquires, from the second communication device, a position of the second communication device and second quality information about communication quality with the plurality of links;
acquires second communication information about the second communication device, from the second communication device;
uses the first communication information, the second communication information, the first quality information, and the second quality information to determine the communication route between the communication device and the second communication device, the communication route satisfying a desired quality; and
notifies the communication device and the second communication device of route information about the determined communication route.

28. A communication system comprising:
a first communication device that is positioned in a first site having a first base station arranged therein to be connected to a first private network and that is connectable to a plurality of links including the first private network;
a second communication device that is positioned in a second site having a second base station arranged therein to be connected to a second private network, the second private network being different from the first private network, the second site being different from the first site, the second communication device being connectable to the plurality of links including the second private network; and
a control apparatus that controls a communication route between the first communication device and the second communication device, wherein
the first communication device transmits a position of the first communication device and first quality information about communication quality with the plurality of links, to the control apparatus,
the second communication device transmits a position of the second communication device and second quality information about communication quality with the plurality of links, to the control apparatus,
the first communication device transmits first communication information about the first communication device to the control apparatus,
the second communication device transmits second communication information about the second communication device to the control apparatus,
the control apparatus uses the first communication information, the second communication information, the first quality information, and the second quality information to determine the communication route between the first communication device and the second communication device, the communication route satisfying a desired quality; and
notifies the first communication device and the second communication device of route information about the determined communication route, and
the first communication device and the second communication device perform communication based on the route information.
